(19) United States
(12) Patent Application Publication
(10) Pub. No.: US 2012/0114861 A1
(43) Pub. Date: May 10, 2012

(54) Electrochemical Fabrication Methods for Producing Multilayer Structures Including the use of Diamond Machining in the Planarization of Deposits of Material

(75) Inventors: Adam L. Cohen, Los Angeles, CA (US); Uri Frodis, Los Angeles, CA (US); Michael S. Lockard, Lake Elizabeth, CA (US); Ananda H. Kumar, Fremont, CA (US); Gang Zhang, Monterey Park, CA (US); Dennis R. Smalley, Newhall, CA (US)

(73) Assignee: Microfabrica Inc.

(21) Appl. No.: 13/253,856

(22) Filed: Oct. 5, 2011

Related U.S. Application Data
(63) Continuation of application No. 12/121,625, filed on May 15, 2008, now abandoned.
Application No. 12/121,625 is a continuation-in-part of application No. 11/029,165, filed on Jan. 3, 2005, now abandoned.
(60) Provisional application No. 60/534,159, filed on Dec. 31, 2003.
(60) Provisional application No. 60/534,183, filed on Dec. 31, 2003.

(51) Int. Cl. B05D 3/12; B05D 1/36; C25D 5/48

(52) U.S. Cl. 427/355; 205/220; 205/223

(57) ABSTRACT

Electrochemical fabrication methods for forming single and multilayer mesoscale and microscale structures include the use of diamond machining (e.g. fly cutting or turning) to planarize layers. Some embodiments focus on systems of sacrificial and structural materials which can be diamond machined with minimal tool wear (e.g. Ni—P and Cu, Au and Cu, Cu and Sn, Au and Cu, Au and Sn, and Au and Sn—Pb). Some embodiments provide for reducing tool wear when using difficult-to-machine materials by (1) depositing difficult to machine materials selectively and potentially with little excess plating thickness and/or (2) pre-machining depositions to within a small increment of desired surface level (e.g. using lapping) and then using diamond fly cutting to complete the process, and/or (3) forming structures or portions of structures from thin walled regions of hard-to-machine material as opposed to wide solid regions of structural material.

### RELATED APPLICATIONS

This application is a continuation of U.S. patent application Ser. No. 12/121,625, filed May 15, 2008 (Microfabrica Docket No. P-US209-A-MF). The '625 application is a continuation in part (CIP) of U.S. patent application Ser. No. 11/029,165 (US133-A), filed Jan. 3, 2005, now abandoned. The '165 application claims benefit of U.S. Provisional Patent Application Nos. 60/534,159, and 60/534,183, both filed Dec. 31, 2003. Each of these referenced applications is incorporated herein by reference.

### FIELD OF THE INVENTION

The present invention relates generally to the field of electrochemical fabrication and the associated formation of three-dimensional structures (e.g. microscale or mesoscale structures). In particular, it relates to electrochemical fabrication processes that utilize diamond machining during the planarization of deposited materials.

### BACKGROUND OF THE INVENTION

A technique for forming three-dimensional structures (e.g. parts, components, devices, and the like) from a plurality of adhered layers was invented by Adam L. Cohen and is known as Electrochemical Fabrication. It is being commercially pursued by Microfabrica® Inc. (formerly MEMGen Corporation) of Van Nuys, Calif. under the name EFAB®. This technique was described in U.S. Pat. No. 6,027,630, issued on Feb. 22, 2000. This electrochemical deposition technique allows the selective deposition of a material using a unique masking technique that involves the use of a mask that includes patterned conformable material on a support structure that is independent of the substrate onto which plating will occur. When desiring to perform an electrodeposition using the mask, the conformable portion of the mask is brought into contact with a substrate while in the presence of a plating solution such that the contact of the conformable portion of the mask to the substrate inhibits deposition at selected locations. For convenience, these masks might be generically called conformable contact masks; the masking technique may be generically called a conformable contact mask plating process. More specifically, in the terminology of Microfabrica® Inc. (formerly MEMGen Corporation) of Van Nuys, Calif. such masks have come to be known as INSTANT MASKS™ and the process known as INSTANT MASKING™ or INSTANT MASK™ plating. Selective depositions using conformable contact mask plating may be used to form single layers of material or may be used to form multi-layer structures. The teachings of the '630 patent are hereby incorporated herein by reference as if set forth in full herein. Since the filing of the patent application that led to the above noted patent, various papers about conformable contact mask plating (i.e. INSTANT MASKING) and electrochemical fabrication have been published:
(1) A. Cohen, G. Zhang, F. Tseng, F. Mansfeld, U. Frodis and P. Will, “EFAB: Batch production of functional, fully-dense metal parts with micro-scale features”, Proc. 9th Solid Freeform Fabrication, The University of Texas at Austin, p 161, August 1998.
(2) A. Cohen, G. Zhang, F. Tseng, F. Mansfeld, U. Frodis and P. Will, “EFAB: Rapid, Low-Cost Desktop Micromachining of High Aspect Ratio True 3-D MEMS”, Proc. 12th IEEE Micro Electro Mechanical Systems Workshop, IEEE, p 244, January 1999.
(3) A. Cohen, “3-D Micromachining by Electrochemical Fabrication”, Micromachine Devices, March 1999.
(4) G. Zhang, A. Cohen, U. Frodis, F. Tseng, F. Mansfeld, and P. Will, “EFAB: Rapid Desktop Manufacturing of True 3-D Microstructures”, Proc. 2nd International Conference on Integrated MicroNanotechnology for Space Applications, The Aerospace Co., April 1999.
(5) F. Tseng, U. Frodis, G. Zhang, A. Cohen, F. Mansfeld, and P. Will, “EFAB: High Aspect Ratio, Arbitrary 3-D Metal Microstructures using a Low-Cost Automated Batch Process”, 3rd International Workshop on High Aspect Ratio MicroStructure Technology (HARMST'99), June 1999.
(6) A. Cohen, U. Frodis, F. Tseng, G. Zhang, F. Mansfeld, and P. Will, “EFAB: Low-Cost, Automated Electrochemical Batch Fabrication of Arbitrary 3-D Microstructures”, Micromachining and Microfabrication Process Technology, SPIE 1999 Symposium on Micromachining and Microfabrication, September 1999.
(7) F. Tseng, G. Zhang, U. Frodis, A. Cohen, F. Mansfeld, and P. Will, “EFAB: High Aspect Ratio, Arbitrary 3-D Metal Microstructures using a Low-Cost Automated Batch Process”, MEMS Symposium, ASME 1999 International Mechanical Engineering Congress and Exposition, November, 1999.
(8) A. Cohen, “Electrochemical Fabrication (EFABTM)”, Chapter 19 of The MEMS Handbook, edited by Mohamed Gad-El-Hak, CRC Press, 2002.
(9) Microfabrication—Rapid Prototyping's Killer Application”, pages 1-5 of the Rapid Prototyping Report, CAD/CAM Publishing, Inc., June 1999.

The disclosures of these nine publications are hereby incorporated herein by reference as if set forth in full herein.

The electrochemical deposition process may be carried out in a number of different ways as set forth in the above patent and publications. In one form, this process involves the execution of three separate operations during the formation of each layer of the structure that is to be formed:
1. Selectively depositing at least one material by electrodeposition upon one or more desired regions of a substrate.
2. Then, blanket depositing at least one additional material by electrodeposition so that the additional deposit covers both the regions that were previously selectively deposited onto, and the regions of the substrate that did not receive any previously applied selective depositions.
3. Finally, planarizing the materials deposited during the first and second operations to produce a smoothed surface of a first layer of desired thickness having at least one region containing the at least one material and at least one region containing at least the one additional material.

After formation of the first layer, one or more additional layers may be formed adjacent to the immediately preceding layer and adhered to the smoothed surface of that preceding layer. These additional layers are formed by repeating the first through third operations one or more times wherein the formation of each subsequent layer treats the previously formed layers and the initial substrate as a new and thickening substrate.

Once the formation of all layers has been completed, at least a portion of at least one of the materials deposited is generally removed by an etching process to expose or release the three-dimensional structure that was intended to be formed.

The preferred method of performing the selective electrodeposition involved in the first operation is by conformable contact mask plating. In this type of plating, one or more conformable contact (CC) masks are first formed. The CC masks include a support structure onto which a patterned conformable dielectric material is adhered or formed. The conformable material for each mask is shaped in accordance with a particular cross-section of material to be plated. At least one CC mask is needed for each unique cross-sectional pattern that is to be plated.

The support for a CC mask is typically a plate-like structure formed of a metal that is to be selectively electroplated and from which material to be plated will be dissolved. In this typical approach, the support will act as an anode in an electroplating process. In an alternative approach, the support may instead be a porous or otherwise perforated material through which deposition material will pass during an electroplating operation on its way from a distal anode to a deposition surface. In either approach, it is possible for CC masks to share a common support, i.e. the patterns of conformable dielectric material for plating multiple layers of material may be located in different areas of a single support structure. When a single support structure contains multiple plating patterns, the entire structure is referred to as the CC mask while the individual plating masks may be referred to as “submasks”. In the present application such a distinction will be made only when relevant to a specific point being made.

In preparation for performing the selective deposition of the first operation, the conformable portion of the CC mask is placed in registration with and pressed against a selected portion of the substrate (or onto a previously formed layer or onto a previously deposited portion of a layer) on which deposition is to occur. The pressing together of the CC mask and substrate occur in such a way that all openings, in the conformable portions of the CC mask contain plating solution. The conformable material of the CC mask that contacts the substrate acts as a barrier to electrodeposition while the openings in the CC mask that are filled with electroplating solution act as pathways for transferring material from an anode (e.g. the CC mask support) to the non-contacted portions of the substrate (which act as a cathode during the plating operation) when an appropriate potential and/or current are supplied.

An example of a CC mask and CC mask plating are shown in FIGS. 1A-1C. FIG. 1A shows a side view of a CC mask 8 consisting of a conformable or deformable (e.g. elastomeric) insulator 10 patterned on an anode 12. The anode has two functions. FIG. 1A also depicts a substrate 6 separated from mask 8. One is as a supporting material for the patterned insulator 10 to maintain its integrity and alignment since the pattern may be topologically complex (e.g., involving isolated “islands” of insulator material). The other function is as an anode for the electroplating operation. CC mask plating selectively deposits material 22 onto a substrate 6 by simply pressing the insulator against the substrate then electrodepositing material through apertures 26a and 26b in the insulator as shown in FIG. 1B. After deposition, the CC mask is separated, preferably non-destructively, from the substrate 6 as shown in FIG. 1C. The CC mask plating process is distinct from a “through-mask” plating process in that in a through-mask plating process the separation of the masking material from the substrate would occur destructively. As with through-mask plating, CC mask plating deposits material selectively and simultaneously over the entire layer. The plated region may consist of one or more isolated plating regions where these isolated plating regions may belong to a single structure that is being formed or may belong to multiple structures that are being formed simultaneously. In CC mask plating as individual masks are not intentionally destroyed in the removal process, they may be usable in multiple plating operations.

Another example of a CC mask and CC mask plating is shown in FIGS. 1D-1F. FIG. 1D shows an anode 12′ separated from a mask 8′ that includes a patterned conformable material 10′ and a support structure 20. FIG. 1D also depicts substrate 6 separated from the mask 8′. FIG. 1E illustrates the mask 8′ being brought into contact with the substrate 6. FIG. 1F illustrates the deposit 22′ that results from conducting a current from the anode 12′ to the substrate 6. FIG. 1G illustrates the deposit 22′ on substrate 6 after separation from mask 8′. In this example, an appropriate electrolyte is located between the substrate 6 and the anode 12′ and a current of ions coming from one or both of the solution and the anode are conducted through the opening in the mask to the substrate where material is deposited. This type of mask may be referred to as an anodeless INSTANT MASK™ (AIM) or as an anodeless conformable contact (ACC) mask.

Unlike through-mask plating, CC mask plating allows CC masks to be formed completely separate from the fabrication of the substrate on which plating is to occur (e.g. separate from a three-dimensional (3D) structure that is being formed). CC masks may be formed in a variety of ways, for example, a photolithographic process may be used. All masks can be generated simultaneously, prior to structure fabrication rather than during it. This separation makes possible a simple, low-cost, automated, self-contained, and internally-clean “desktop factory” that can be installed almost anywhere to fabricate 3D structures, leaving any required clean room processes, such as photolithography to be performed by service bureaus or the like.

An example of the electrochemical fabrication process discussed above is illustrated in FIGS. 2A-2F. These figures show that the process involves deposition of a first material 2 which is a sacrificial material and a second material 4 which is a structural material. The CC mask 8, in this example, includes a patterned conformable material (e.g. an elastomeric dielectric material) 10 and a support 12 which is made from deposition material 2. The conformal portion of the CC mask is pressed against substrate 6 with a plating solution 14 located within the openings 16 in the conformable material 10. An electric current, from power supply 18, is then passed through the plating solution 14 via (a) support 12 which doubles as an anode and (b) substrate 6 which doubles as a cathode. FIG. 2A, illustrates that the passing of current causes material 2 within the plating solution and material 2 from the anode 12 to be selectively transferred to and plated on the cathode 6. After electroplating the first deposition material 2 onto the substrate 6 using CC mask 8, the CC mask 8 is removed as shown in FIG. 2B. FIG. 2C depicts the second deposition material 4 as having been blanket-deposited (i.e. non-selectively deposited) over the previously deposited first deposition material 2 as well as over the other portions of the substrate 6. The blanket deposition occurs by electroplating from an anode (not shown), composed of the second material, through an appropriate plating solution (not shown), and to the cathode/substrate 6. The entire two-material layer is then planarized to achieve precise thickness and flatness as shown in FIG. 2D. After repetition of this process for all layers, the multi-layer structure 20 formed of the second material 4 (i.e. structural material) is embedded in first material 2 (i.e. sacrificial material) as shown in FIG. 2E. The embedded structure is etched to yield the desired device, i.e. structure 20, as shown in FIG. 2F.

Various components of an exemplary manual electrochemical fabrication system 32 are shown in FIGS. 3A-3C. The system 32 consists of several subsystems 34, 36, 38, and 40. The substrate holding subsystem 34 is depicted in the upper portions of each of FIGS. 3A to 3C and includes several components: (1) a carrier 48, (2) a metal substrate 6 onto which the layers are deposited, and (3) a linear slide 42 capable of moving the substrate 6 up and down relative to the carrier 48 in response to drive force from actuator 44. Subsystem 34 also includes an indicator 46 for measuring differences in vertical position of the substrate which may be used in setting or determining layer thicknesses and/or deposition thicknesses. The subsystem 34 further includes feet 68 for carrier 48 which can be precisely mounted on subsystem 36.

The CC mask subsystem 36 shown in the lower portion of FIG. 3A includes several components: (1) a CC mask 8 that is actually made up of a number of CC masks (i.e. submasks) that share a common support/anode 12, (2) precision X-stage 54, (3) precision Y-stage 56, (4) frame 72 on which the feet 68 of subsystem 34 can mount, and (5) a tank 58 for containing the electrolyte 16. Subsystems 34 and 36 also include appropriate electrical connections (not shown) for connecting to an appropriate power source for driving the CC masking process.

The blanket deposition subsystem 38 is shown in the lower portion of FIG. 3B and includes several components: (1) an anode 62, (2) an electrolyte tank 64 for holding plating solution 66, and (3) frame 74 on which the feet 68 of subsystem 34 may sit. Subsystem 38 also includes appropriate electrical connections (not shown) for connecting the anode to an appropriate power supply for driving the blanket deposition process.

The planarization subsystem 40 is shown in the lower portion of FIG. 3C and includes a lapping plate 52 and associated motion and control systems (not shown) for planarizing the depositions.

Another method for forming microstructures from electroplated metals (i.e. using electrochemical fabrication techniques) is taught in U.S. Pat. No. 5,190,637 to Henry Guckel, entitled “Formation of Microstructures by Multiple Level Deep X-ray Lithography with Sacrificial Metal layers”. This patent teaches the formation of metal structure utilizing mask exposures. A first layer of a primary metal is electroplated onto an exposed plating base to fill a void in a photoresist, the photoresist is then removed and a secondary metal is electroplated over the first layer and over the plating base. The exposed surface of the secondary metal is then machined down to a height which exposes the first metal to produce a flat uniform surface extending across the both the primary and secondary metals. Formation of a second layer may then begin by applying a photoresist layer over the first layer and then repeating the process used to produce the first layer. The process is then repeated until the entire structure is formed and the secondary metal is removed by etching. The photoresist is formed over the plating base or previous layer by casting and the voids in the photoresist are formed by exposure of the photoresist through a patterned mask via X-rays or UV radiation. This reference mentions the use of a diamond fly cutter (e.g. the Jung-Reichart ultramiller) in the planarization of layers but it proposes the use of such a technique for planarizing layers formed of nickel and silver.

Even though electrochemical fabrication as taught and practiced to date, has greatly enhanced the capabilities of microfabrication, and in particular added greatly to the number of metal layers that can be incorporated into a structure and to the speed and simplicity in which such structures can be made, room for enhancing the state of electrochemical fabrication exists. In particular, improved techniques for combining electrochemical fabrication methods in combination with diamond machining (i.e. single point diamond fly cutting or single point diamond turning) would be beneficial.

### SUMMARY OF THE INVENTION

It is an object of some embodiments of the invention to provide electrochemical fabrication processes with enhanced capabilities.

It is an object of some embodiments of the invention to provide more rapid planarization of deposited materials during multi-layer electrochemical fabrication of structures.

It is an object of some embodiments of the invention to provide enhanced and/or more reliable surface finish of planarized materials.

It is an object of some embodiments of the invention to provide enhanced electrochemical fabrication embodiments that can reliably and efficient make use of fly cutting to planarize deposited materials.

Other objects and advantages of various embodiments of the invention will be apparent to those of skill in the art upon review of the teachings herein. The various embodiments and aspects of the invention, set forth explicitly herein or otherwise ascertained from the teachings herein, may address one or more of the above objects alone or in combination, or alternatively may address some other object of the invention ascertained from the teachings herein. It is not necessarily intended that all objects be addressed by any single embodiment or aspect of the invention even though that may be the case with regard to some embodiments and aspects.

In a first aspect of the invention, a process for forming a multilayer three-dimensional structure, including: (a) forming and adhering a layer of material to a previously formed layer and/or to a substrate, wherein the layer comprises a desired pattern of at least one material, wherein one or more contact pads exist on the substrate or on a previously formed layer; (b) subjecting the at least one material to a planarization operation which comprises diamond machining (c) repeating the forming and adhering of operation (a) one or more time to form the three-dimensional structure from a plurality of adhered layers.

In a second aspect of the invention, the process of the preceding aspect wherein the planarization operation includes at least one lapping operation or rough cutting operation that brings height of deposition to a level which is closer to that of the final desired level and after which the diamond machining operation brings the level of the deposited materials to a level that is within a defined tolerance of a desired level.

Further aspects of the invention will be understood by those of skill in the art upon reviewing the teachings herein. Other aspects of the invention may involve apparatus that can be used in implementing one or more of the method aspects of the invention. These other aspects of the invention may provide various combinations of the aspects presented above or of embodiments presented hereafter as well as provide other configurations, structures, functional relationships, and processes that have not been specifically set forth above.

### BRIEF DESCRIPTION OF THE DRAWINGS

FIGS. 1A-1C schematically depict side views of various stages of a CC mask plating process, while FIGS. 1D-G schematically depict a side views of various stages of a CC mask plating process using a different type of CC mask.

FIGS. 2A-2F schematically depict side views of various stages of an electrochemical fabrication process as applied to the formation of a particular structure where a sacrificial material is selectively deposited while a structural material is blanket deposited.

FIGS. 3A-3C schematically depict side views of various example subassemblies that may be used in manually implementing the electrochemical fabrication method depicted in FIGS. 2A-2F.

FIGS. 4A-4I schematically depict the formation of a first layer of a structure using adhered mask plating where the blanket deposition of a second material overlays both the openings between deposition locations of a first material and the first material itself.

FIG. 5A provides a flowchart of an electrochemical fabrication process that may be used in practicing some embodiments of the invention.

FIGS. 5B-5I provide block diagrams of operations that may be used during the formation of a single layer of a structure or during the formation of each of a plurality of layers of a multi-layer structure according to first through tenth embodiments of the invention where the outlined operations may be used as operations oₙ in the process of FIG. 5A for the formation of some or all layers of the structures.

FIG. 6 provides a block diagram of a ninth embodiment of the invention.

### DETAILED DESCRIPTION OF PREFERRED EMBODIMENTS OF THE INVENTION

### Electrochemical Fabrication in General

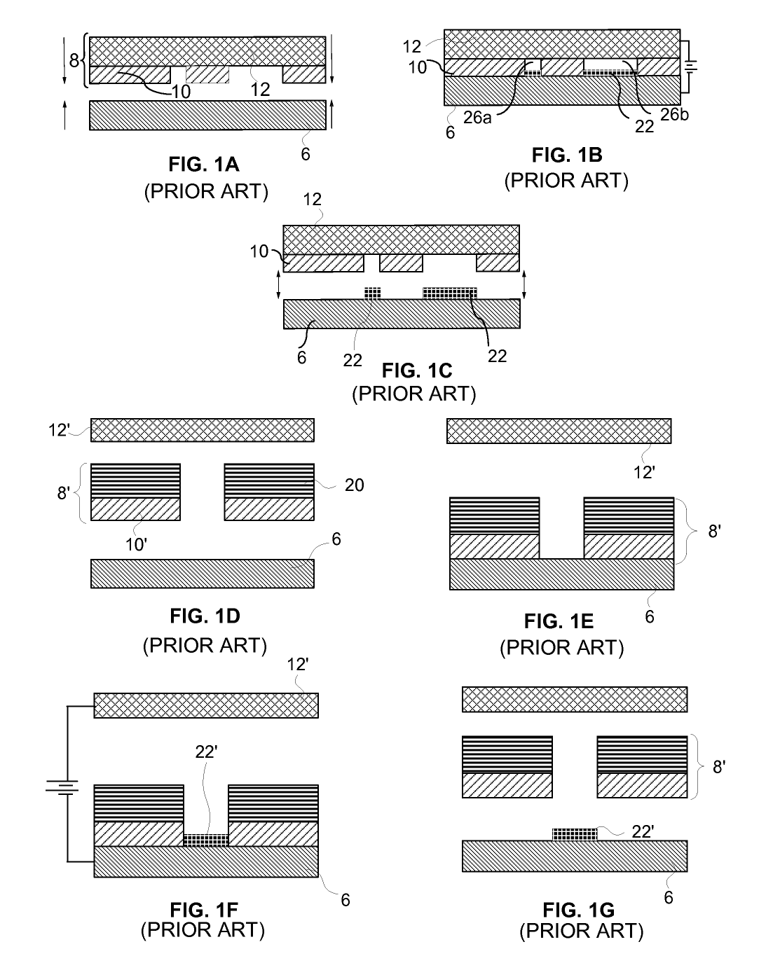

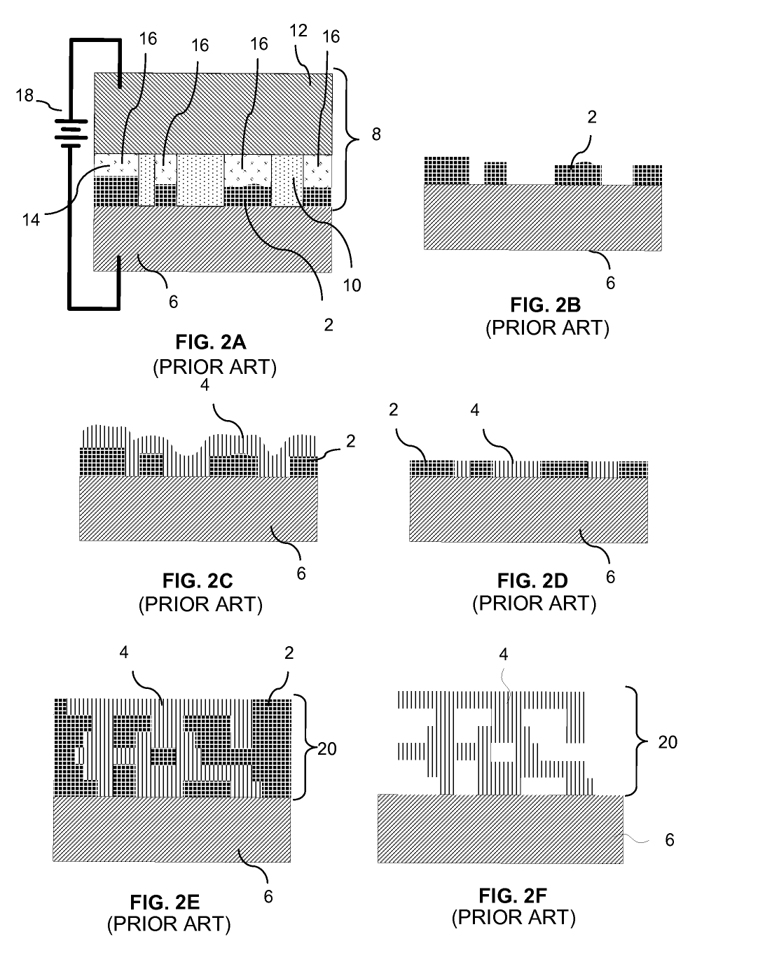

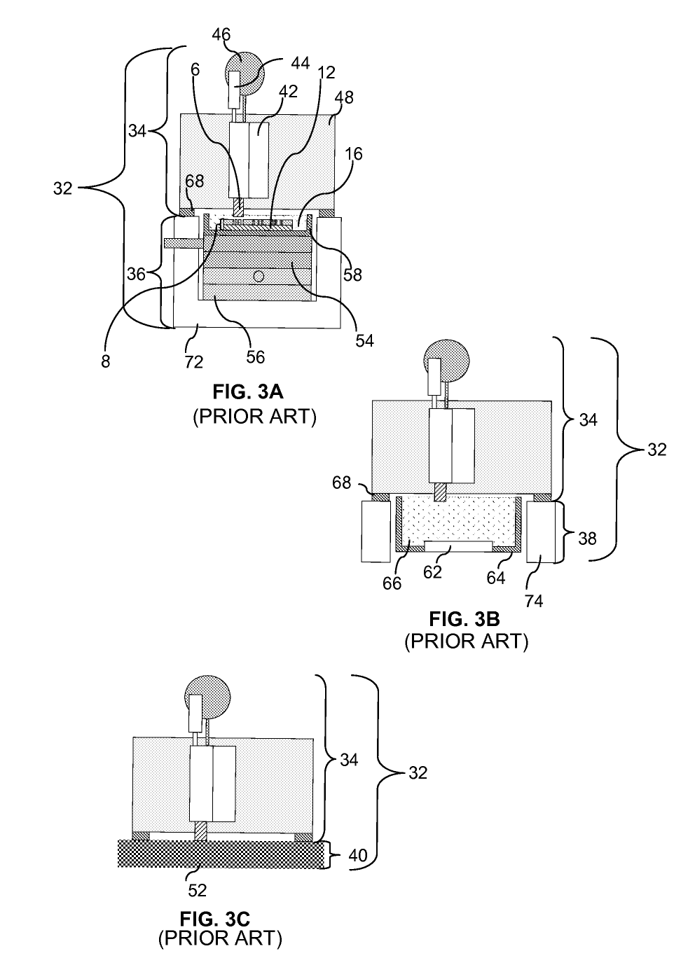

FIGS. 1A-1G, 2A-2F, and 3A-3C illustrate various features of one form of electrochemical fabrication. Other electrochemical fabrication techniques are set forth in the '630 patent referenced above, in the various previously incorporated publications, in various other patents and patent applications incorporated herein by reference. Still others may be derived from combinations of various approaches described in these publications, patents, and applications, or are otherwise known or ascertainable by those of skill in the art from the teachings set forth herein. All of these techniques may be combined with those of the various embodiments of various aspects of the invention to yield enhanced embodiments. Still other embodiments may be derived from combinations of the various embodiments explicitly set forth herein.

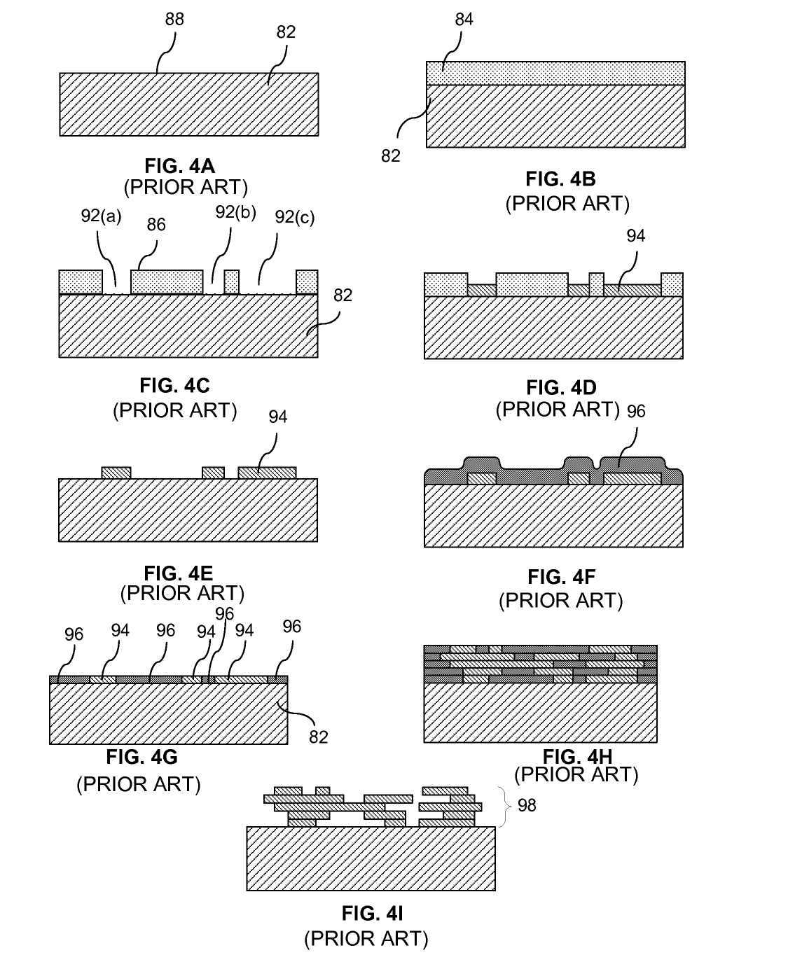

FIGS. 4A-4I illustrate various stages in the formation of a single layer of a multi-layer fabrication process where a second metal is deposited on a first metal as well as in openings in the first metal so that the first and second metal form part of the layer. In FIG. 4A a side view of a substrate 82 is shown, onto which patternable photoresist 84 is cast as shown in FIG. 4B. In FIG. 4C, a pattern of resist is shown that results from the curing, exposing, and developing of the resist. The patterning of the photoresist 84 results in openings or apertures 92(a)-92(c) extending from a surface 86 of the photoresist through the thickness of the photoresist to surface 88 of the substrate 82. In FIG. 4D a metal 94 (e.g. nickel) is shown as having been electroplated into the openings 92(a)-92(c). In FIG. 4E the photoresist has been removed (i.e. chemically stripped) from the substrate to expose regions of the substrate 82 which are not covered with the first metal 94. In FIG. 4F a second metal 96 (e.g. silver) is shown as having been blanket electroplated over the entire exposed portions of the substrate 82 (which is conductive) and over the first metal 94 (which is also conductive). FIG. 4G depicts the completed first layer of the structure which has resulted from the planarization of the first and second metals down to a height that exposes the first metal and sets a thickness for the first layer. In FIG. 4H the result of repeating the process steps shown in FIGS. 4B-4 G several times to form a multi-layer structure are shown where each layer consists of two materials. For most applications, one of these materials is removed as shown in FIG. 4I to yield a desired 3-D structure 98 (e.g. component or device).

Various embodiments of various aspects of the invention are directed to formation of three-dimensional structures from materials some of which may be electrodeposited or electroless deposited. Some of these structures may be formed form a single build level formed from one or more deposited materials while others are formed from a plurality of build layers each including at least two materials (e.g. two or more layers, more preferably five or more layers, and most preferably ten or more layers). In some embodiments, layer thicknesses may be as small as one micron or as large as fifty microns. In other embodiments, thinner layers may be used while in other embodiments, thicker layers may be used. In some embodiments structures having features positioned with micron level precision and minimum features size on the order of tens of microns are to be formed. In other embodiments structures with less precise feature placement and/or larger minimum features may be formed. In still other embodiments, higher precision and smaller minimum feature sizes may be desirable. In the present application meso-scale and millimeter scale have the same meaning and refer to devices that may have one or more dimensions extending into the 0.5-20 millimeter range, or somewhat larger and with features positioned with precision in the 10-100 micron range and with minimum features sizes on the order of 100 microns.

The various embodiments, alternatives, and techniques disclosed herein may form multi-layer structures using a single patterning technique on all layers or using different patterning techniques on different layers. For example, Various embodiments of the invention may perform selective patterning operations using conformable contact masks and masking operations (i.e. operations that use masks which are contacted to but not adhered to a substrate), proximity masks and masking operations (i.e. operations that use masks that at least partially selectively shield a substrate by their proximity to the substrate even if contact is not made), non-conformable masks and masking operations (i.e. masks and operations based on masks whose contact surfaces are not significantly conformable), and/or adhered masks and masking operations (masks and operations that use masks that are adhered to a substrate onto which selective deposition or etching is to occur as opposed to only being contacted to it). Conformable contact masks, proximity masks, and non-conformable contact masks share the property that they are preformed and brought to, or in proximity to, a surface which is to be treated (i.e. the exposed portions of the surface are to be treated). These masks can generally be removed without damaging the mask or the surface that received treatment to which they were contacted, or located in proximity to. Adhered masks are generally formed on the surface to be treated (i.e. the portion of that surface that is to be masked) and bonded to that surface such that they cannot be separated from that surface without being completely destroyed damaged beyond any point of reuse. Adhered masks may be formed in a number of ways including (1) by application of a photoresist, selective exposure of the photoresist, and then development of the photoresist, (2) selective transfer of pre-patterned masking material, and/or (3) direct formation of masks from computer controlled depositions of material.

Patterning operations may be used in selectively depositing material and/or may be used in the selective etching of material. Selectively etched regions may be selectively filled in or filled in via blanket deposition, or the like, with a different desired material. In some embodiments, the layer-by-layer build up may involve the simultaneous formation of portions of multiple layers. In some embodiments, depositions made in association with some layer levels may result in depositions to regions associated with other layer levels (i.e. regions that lie within the top and bottom boundary levels that define a different layer's geometric configuration). Such use of selective etching and interlaced material deposition in association with multiple layers is described in U.S. patent application Ser. No. 10/434,519, by Smalley, and entitled “Methods of and Apparatus for Electrochemically Fabricating Structures Via Interlaced Layers or Via Selective Etching and Filling of Voids layer elements” which is hereby incorporated herein by reference as if set forth in full.

Temporary substrates on which structures may be formed may be of the sacrificial-type (i.e. destroyed or damaged during separation of deposited materials to the extent they can not be reused), non-sacrificial-type (i.e. not destroyed or excessively damaged, i.e. not damaged to the extent they may not be reused, e.g. with a sacrificial or release layer located between the substrate and the initial layers of a structure that is formed). Non-sacrificial substrates may be considered reusable, with little or no rework (e.g. replanarizing one or more selected surfaces or applying a release layer, and the like) though they may or may not be reused for a variety of reasons.

### DEFINITIONS

This section of the specification is intended to set forth definitions for a number of specific terms that may be useful in describing the subject matter of the various embodiments of the invention. It is believed that the meanings of most if not all of these terms is clear from their general use in the specification but they are set forth hereinafter to remove any ambiguity that may exist. It is intended that these definitions be used in understanding the scope and limits of any claims that use these specific terms. As far as interpretation of the claims of this patent disclosure are concerned, it is intended that these definitions take presence over any contradictory definitions or allusions found in any materials which are incorporated herein by reference.

“Build” as used herein refers, as a verb, to the process of building a desired structure or plurality of structures from a plurality of applied or deposited materials which are stacked and adhered upon application or deposition or, as a noun, to the physical structure or structures formed from such a process. Depending on the context in which the term is used, such physical structures may include a desired structure embedded within a sacrificial material or may include only desired physical structures which may be separated from one another or may require dicing and/or slicing to cause separation.

“Build axis” or “build orientation” is the axis or orientation that is substantially perpendicular to substantially planar levels of deposited or applied materials that are used in building up a structure. The planar levels of deposited or applied materials may be or may not be completely planar but are substantially so in that the overall extent of their cross-sectional dimensions are significantly greater than the height of any individual deposit or application of material (e.g. 100, 500, 1000, 5000, or more times greater). The planar nature of the deposited or applied materials may come about from use of a process that leads to planar deposits or it may result from a planarization process (e.g. a process that includes mechanical abrasion, e.g. lapping, fly cutting, grinding, or the like) that is used to remove material regions of excess height. Unless explicitly noted otherwise, “vertical” as used herein refers to the build axis or nominal build axis (if the layers are not stacking with perfect registration) while “horizontal” refers to a direction within the plane of the layers (i.e. the plane that is substantially perpendicular to the build axis).

“Build layer” or “layer of structure” as used herein does not refer to a deposit of a specific material but instead refers to a region of a build located between a lower boundary level and an upper boundary level which generally defines a single cross-section of a structure being formed or structures which are being formed in parallel. Depending on the details of the actual process used to form the structure, build layers are generally formed on and adhered to previously formed build layers. In some processes the boundaries between build layers are defined by planarization operations which result in successive build layers being formed on substantially planar upper surfaces of previously formed build layers. In some embodiments, the substantially planar upper surface of the preceding build layer may be textured to improve adhesion between the layers. In other build processes, openings may exist in or be formed in the upper surface of a previous but only partially formed build layers such that the openings in the previous build layers are filled with materials deposited in association with current build layers which will cause interlacing of build layers and material deposits. Such interlacing is described in U.S. patent application Ser. No. 10/434,519. This referenced application is incorporated herein by reference as if set forth in full. In most embodiments, a build layer includes at least one primary structural material and at least one primary sacrificial material. However, in some embodiments, two or more primary structural materials may used without a primary sacrificial material (e.g. when one primary structural material is a dielectric and the other is a conductive material). In some embodiments, build layers are distinguishable from each other by the source of the data that is used to yield patterns of the deposits, applications, and/or etchings of material that form the respective build layers. For example, data descriptive of a structure to be formed which is derived from data extracted from different vertical levels of a data representation of the structure define different build layers of the structure. The vertical separation of successive pairs of such descriptive data may define the thickness of build layers associated with the data. As used herein, at times, “build layer” may be loosely referred simply as “layer”. In many embodiments, deposition thickness of primary structural or sacrificial materials (i.e. the thickness of any particular material after it is deposited) is generally greater than the layer thickness and a net deposit thickness is set via one or more planarization processes which may include, for example, mechanical abrasion (e.g. lapping, fly cutting, polishing, and the like) and/or chemical etching (e.g. using selective or non-selective etchants). The lower boundary and upper boundary for a build layer may be set and defined in different ways. From a design point of view they may be set based on a desired vertical resolution of the structure (which may vary with height). From a data manipulation point of view, the vertical layer boundaries may be defined as the vertical levels at which data descriptive of the structure is processed or the layer thickness may be defined as the height separating successive levels of cross-sectional data that dictate how the structure will be formed. From a fabrication point of view, depending on the exact fabrication process used, the upper and lower layer boundaries may be defined in a variety of different ways. For example by planarization levels or effective planarization levels (e.g. lapping levels, fly cutting levels, chemical mechanical polishing levels, mechanical polishing levels, vertical positions of structural and/or sacrificial materials after relatively uniform etch back following a mechanical or chemical mechanical planarization process). For example, by levels at which process steps or operations are repeated. At levels at which, at least theoretically, lateral extends of structural material can be changed to define new cross-sectional features of a structure.

“Layer thickness” is the height along the build axis between a lower boundary of a build layer and an upper boundary of that build layer.

“Planarization” is a process that tends to remove materials, above a desired plane, in a substantially non-selective manner such that all deposited materials are brought to a substantially common height or desired level (e.g. within 20%, 10%, 5%, or even 1% of a desired layer boundary level). For example, lapping removes material in a substantially non-selective manner though some amount of recession one material or another may occur (e.g. copper may recess relative to nickel). Planarization may occur primarily via mechanical means, e.g. lapping, grinding, fly cutting, milling, sanding, abrasive polishing, frictionally induced melting, other machining operations, or the like (i.e. mechanical planarization). Mechanical planarization maybe followed or proceeded by thermally induced planarization (.e.g. melting) or chemically induced planarization (e.g. etching). Planarization may occur primarily via a chemical and/or electrical means (e.g. chemical etching, electrochemical etching, or the like). Planarization may occur via a simultaneous combination of mechanical and chemical etching (e.g. chemical mechanical polishing (CMP)).

“Structural material” as used herein refers to a material that remains part of the structure when put into use.

“Supplemental structural material” as used herein refers to a material that forms part of the structure when the structure is put to use but is not added as part of the build layers but instead is added to a plurality of layers simultaneously (e.g. via one or more coating operations that applies the material, selectively or in a blanket fashion, to a one or more surfaces of a desired build structure that has been released from a sacrificial material.

“Primary structural material” as used herein is a structural material that forms part of a given build layer and which is typically deposited or applied during the formation of that build layer and which makes up more than 20% of the structural material volume of the given build layer. In some embodiments, the primary structural material may be the same on each of a plurality of build layers or it may be different on different build layers. In some embodiments, a given primary structural material may be formed from two or more materials by the alloying or diffusion of two or more materials to form a single material.

“Secondary structural material” as used herein is a structural material that forms part of a given build layer and is typically deposited or applied during the formation of the given build layer but is not a primary structural material as it individually accounts for only a small volume of the structural material associated with the given layer. A secondary structural material will account for less than 20% of the volume of the structural material associated with the given layer. In some preferred embodiments, each secondary structural material may account for less than 10%, 5%, or even 2% of the volume of the structural material associated with the given layer. Examples of secondary structural materials may include seed layer materials, adhesion layer materials, barrier layer materials (e.g. diffusion barrier material), and the like. These secondary structural materials are typically applied to form coatings having thicknesses less than 2 microns, 1 micron, 0.5 microns, or even 0.2 microns). The coatings may be applied in a conformal or directional manner (e.g. via CVD, PVD, electroless deposition, or the like). Such coatings may be applied in a blanket manner or in a selective manner. Such coatings may be applied in a planar manner (e.g. over previously planarized layers of material) as taught in U.S. patent application Ser. No. 10/607,931. In other embodiments, such coatings may be applied in a non-planar manner, for example, in openings in and over a patterned masking material that has been applied to previously planarized layers of material as taught in U.S. patent application Ser. No. 10/841,383. These referenced applications are incorporated herein by reference as if set forth in full herein.

“Functional structural material” as used herein is a structural material that would have been removed as a sacrificial material but for its actual or effective encapsulation by other structural materials. Effective encapsulation refers, for example, to the inability of an etchant to attack the functional structural material due to inaccessibility that results from a very small area of exposure and/or due to an elongated or tortuous exposure path. For example, large (10,000 μm²) but thin (e.g. less than 0.5 microns) regions of sacrificial copper sandwiched between deposits of nickel may define regions of functional structural material depending on ability of a release etchant to remove the sandwiched copper.

“Sacrificial material” is material that forms part of a build layer but is not a structural material. Sacrificial material on a given build layer is separated from structural material on that build layer after formation of that build layer is completed and more generally is removed from a plurality of layers after completion of the formation of the plurality of layers during a “release” process that removes the bulk of the sacrificial material or materials. In general sacrificial material is located on a build layer during the formation of one, two, or more subsequent build layers and is thereafter removed in a manner that does not lead to a planarized surface. Materials that are applied primarily for masking purposes, i.e. to allow subsequent selective deposition or etching of a material, e.g. photoresist that is used in forming a build layer but does not form part of the build layer) or that exist as part of a build for less than one or two complete build layer formation cycles are not considered sacrificial materials as the term is used herein but instead shall be referred as masking materials or as temporary materials. These separation processes are sometimes referred to as a release process and may or may not involve the separation of structural material from a build substrate. In many embodiments, sacrificial material within a given build layer is not removed until all build layers making up the three-dimensional structure have been formed. Of course sacrificial material may be, and typically is, removed from above the upper level of a current build layer during planarization operations during the formation of the current build layer. Sacrificial material is typically removed via a chemical etching operation but in some embodiments may be removed via a melting operation or electrochemical etching operation. In typical structures, the removal of the sacrificial material (i.e. release of the structural material from the sacrificial material) does not result in planarized surfaces but instead results in surfaces that are dictated by the boundaries of structural materials located on each build layer. Sacrificial materials are typically distinct from structural materials by having different properties therefrom (e.g. chemical etchability, hardness, melting point, etc.) but in some cases, as noted previously, what would have been a sacrificial material may become a structural material by its actual or effective encapsulation by other structural materials. Similarly, structural materials may be used to form sacrificial structures that are separated from a desired structure during a release process via the sacrificial structures being only attached to sacrificial material or potentially by dissolution of the sacrificial structures themselves using a process that is insufficient to reach structural material that is intended to form part of a desired structure. It should be understood that in some embodiments, small amounts of structural material may be removed, after or during release of sacrificial material. Such small amounts of structural material may have been inadvertently formed due to imperfections in the fabrication process or may result from the proper application of the process but may result in features that are less than optimal (e.g. layers with stairs steps in regions where smooth sloped surfaces are desired. In such cases the volume of structural material removed is typically minuscule compared to the amount that is retained and thus such removal is ignored when labeling materials as sacrificial or structural. Sacrificial materials are typically removed by a dissolution process, or the like, that destroys the geometric configuration of the sacrificial material as it existed on the build layers. In many embodiments, the sacrificial material is a conductive material such as a metal. As will be discussed hereafter, masking materials though typically sacrificial in nature are not termed sacrificial materials herein unless they meet the required definition of sacrificial material.

“Supplemental sacrificial material” as used herein refers to a material that does not form part of the structure when the structure is put to use and is not added as part of the build layers but instead is added to a plurality of layers simultaneously (e.g. via one or more coating operations that applies the material, selectively or in a blanket fashion, to a one or more surfaces of a desired build structure that has been released from an initial sacrificial material. This supplemental sacrificial material will remain in place for a period of time and/or during the performance of certain post layer formation operations, e.g. to protect the structure that was released from a primary sacrificial material, but will be removed prior to putting the structure to use.

“Primary sacrificial material” as used herein is a sacrificial material that is located on a given build layer and which is typically deposited or applied during the formation of that build layer and which makes up more than 20% of the sacrificial material volume of the given build layer. In some embodiments, the primary sacrificial material may be the same on each of a plurality of build layers or may be different on different build layers. In some embodiments, a given primary sacrificial material may be formed from two or more materials by the alloying or diffusion of two or more materials to form a single material.

“Secondary sacrificial material” as used herein is a sacrificial material that is located on a given build layer and is typically deposited or applied during the formation of the build layer but is not a primary sacrificial materials as it individually accounts for only a small volume of the sacrificial material associated with the given layer. A secondary sacrificial material will account for less than 20% of the volume of the sacrificial material associated with the given layer. In some preferred embodiments, each secondary sacrificial material may account for less than 10%, 5%, or even 2% of the volume of the sacrificial material associated with the given layer. Examples of secondary structural materials may include seed layer materials, adhesion layer materials, barrier layer materials (e.g. diffusion barrier material), and the like. These secondary sacrificial materials are typically applied to form coatings having thicknesses less than 2 microns, 1 micron, 0.5 microns, or even 0.2 microns). The coatings may be applied in a conformal or directional manner (e.g. via CVD, PVD, electroless deposition, or the like). Such coatings may be applied in a blanket manner or in a selective manner. Such coatings may be applied in a planar manner (e.g. over previously planarized layers of material) as taught in U.S. patent application Ser. No. 10/607,931. In other embodiments, such coatings may be applied in a non-planar manner, for example, in openings in and over a patterned masking material that has been applied to previously planarized layers of material as taught in U.S. patent application Ser. No. 10/841,383. These referenced applications are incorporated herein by reference as if set forth in full herein.

“Adhesion layer”, “seed layer”, “barrier layer”, and the like refer to coatings of material that are thin in comparison to the layer thickness and thus generally form secondary structural material portions or sacrificial material portions of some layers. Such coatings may be applied uniformly over a previously formed build layer, they may be applied over a portion of a previously formed build layer and over patterned structural or sacrificial material existing on a current (i.e. partially formed) build layer so that a non-planar seed layer results, or they may be selectively applied to only certain locations on a previously formed build layer. In the event such coatings are non-selectively applied, selected portions may be removed (1) prior to depositing either a sacrificial material or structural material as part of a current layer or (2) prior to beginning formation of the next layer or they may remain in place through the layer build up process and then etched away after formation of a plurality of build layers.

“Masking material” is a material that may be used as a tool in the process of forming a build layer but does not form part of that build layer. Masking material is typically a photopolymer or photoresist material or other material that may be readily patterned. Masking material is typically a dielectric. Masking material, though typically sacrificial in nature, is not a sacrificial material as the term is used herein. Masking material is typically applied to a surface during the formation of a build layer for the purpose of allowing selective deposition, etching, or other treatment and is removed either during the process of forming that build layer or immediately after the formation of that build layer.

“Multilayer structures” are structures formed from multiple build layers of deposited or applied materials.

“Multilayer three-dimensional (or 3D or 3-D) structures” are Multilayer Structures that meet at least one of two criteria: (1) the structural material portion of at least two layers of which one has structural material portions that do not overlap structural material portions of the other.

“Complex multilayer three-dimensional (or 3D or 3-D) structures” are multilayer three-dimensional structures formed from at least three layers where a line may be defined that hypothetically extends vertically through at least some portion of the build layers of the structure will extend from structural material through sacrificial material and back through structural material or will extend from sacrificial material through structural material and back through sacrificial material (these might be termed vertically complex multilayer three-dimensional structures). Alternatively, complex multilayer three-dimensional structures may be defined as multilayer three-dimensional structures formed from at least two layers where a line may be defined that hypothetically extends horizontally through at least some portion of a build layer of the structure that will extend from structural material through sacrificial material and back through structural material or will extend from sacrificial material through structural material and back through sacrificial material (these might be termed horizontally complex multilayer three-dimensional structures). Worded another way, in complex multilayer three-dimensional structures, a vertically or horizontally extending hypothetical line will extend from one or structural material or void (when the sacrificial material is removed) to the other of void or structural material and then back to structural material or void as the line is traversed along at least a portion of the line.

“Moderately complex multilayer three-dimensional (or 3D or 3-D) structures are complex multilayer 3D structures for which the alternating of void and structure or structure and void not only exists along one of a vertically or horizontally extending line but along lines extending both vertically and horizontally.

“Highly complex multilayer (or 3D or 3-D) structures are complex multilayer 3D structures for which the structure-to-void-to-structure or void-to-structure-to-void alternating occurs once along the line but occurs a plurality of times along a definable horizontally or vertically extending line.

“Up-facing feature” is an element dictated by the cross-sectional data for a given build layer “n” and a next build layer “n+1” that is to be formed from a given material that exists on the build layer “n” but does not exist on the immediately succeeding build layer “n+1”. For convenience the term “up-facing feature” will apply to such features regardless of the build orientation.

“Down-facing feature” is an element dictated by the cross-sectional data for a given build layer “n” and a preceding build layer “n−1” that is to be formed from a given material that exists on build layer “n” but does not exist on the immediately preceding build layer “n−1”. As with up-facing features, the term “down-facing feature” shall apply to such features regardless of the actual build orientation.

“Continuing region” is the portion of a given build layer “n” that is dictated by the cross-sectional data for the given build layer “n”, a next build layer “n+1” and a preceding build layer “n−1” that is neither up-facing nor down-facing for the build layer “n”.

“Minimum feature size” refers to a necessary or desirable spacing between structural material elements on a given layer that are to remain distinct in the final device configuration. If the minimum feature size is not maintained on a given layer, the fabrication process may result in structural material inadvertently bridging the two structural elements due to masking material failure or failure to appropriately fill voids with sacrificial material during formation of the given layer such that during formation of a subsequent layer structural material inadvertently fills the void. More care during fabrication can lead to a reduction in minimum feature size or a willingness to accept greater losses in productivity can result in a decrease in the minimum feature size. However, during fabrication for a given set of process parameters, inspection diligence, and yield (successful level of production) a minimum design feature size is set in one way or another. The above described minimum feature size may more appropriately be termed minimum feature size of sacrificial material regions. Conversely a minimum feature size for structure material regions (minimum width or length of structural material elements) may be specified. Depending on the fabrication method and order of deposition of structural material and sacrificial material, the two types of minimum feature sizes may be different. In practice, for example, using electrochemical fabrication methods and described herein, the minimum features size on a given layer may be roughly set to a value that approximates the layer thickness used to form the layer and it may be considered the same for both structural and sacrificial material widths and lengths. In some more rigorously implemented processes, examination regiments, and rework requirements, it may be set to an amount that is 80%, 50%, or even 30% of the layer thickness. Other values or methods of setting minimum feature sizes may be set.

“Sublayer” as used herein refers to a portion of a build layer that typically includes the full lateral extents of that build layer but only a portion of its height. A sublayer is usually a vertical portion of build layer that undergoes independent processing compared to another sublayer of that build layer.

“Diamond machining” as used herein refers to two different types machining or a combination of them, i.e. (1) single point diamond fly cutting where a diamond cutting tool is moved in a circular or elliptical plane which is brought into contact with a material to be machine by relative motion between the path of the cutting tool and/or (2) single point diamond turning where a diamond cutting tool is held in a fixed position or undergoes translational motion relative to a surface that is to be machined and wherein the surface that is to be machined undergoes rotational motionl.

A first group of embodiments of the invention use diamond machining (i.e. diamond fly cutting or turning) to planarize deposits of materials during the electrochemical fabrication of single layer and multi-layer structures. As diamond machining is not appropriate for effectively machining all materials, embodiments of the invention take on a variety of forms with each having the common element that diamond machining will be used during at least a portion of the planarization operations associated with the formation of one or more layers of a structure being formed. Some embodiments focus on building structures using only structural and sacrificial materials that are readily fly cuttable. Some embodiments, focus on reducing tool wear when one or more of the building materials (e.g. sacrificial materials or structural materials) are hard or difficult to machine (i.e. hard to diamond fly cut).

Many embodiments of electrochemical fabrication processes involve the use of both a structural material and a sacrificial material. In these embodiments, it is desired that the structural material and sacrificial materials meet certain criteria. For example, some common criteria for the structural materials include: (1) desirable physical and chemical properties, (2) relatively low stress, (3) excellent inter-layer adhesion, (4) ability to be deposited over and adequately adhere to sacrificial material, (5) low porosity, and (6) ability to be planarized in conjunction with neighboring regions of sacrificial material using a chosen planarization process without adverse effect on the structure, excessive time and expense spent on performing the planarization process, and with adequate accuracy and repeatability of the process. Some common criteria for sacrificial materials include: (1) excellent etch selectivity with respect to structural material, (2) minimal inter-diffusion with structural material prior to removal, (3) a coefficient of thermal expansion similar to that of the structural material, and (4) ability to be planarized in conjunction with neighboring regions of structural material. Of course, depending on the circumstances, in some embodiments, it may not be necessary for each of these criteria, or even most of these criteria, to be met.

Certain combinations of structural and sacrificial materials have the ability to be planarized using diamond machining with (1) good planarity, both across the wafer and locally (i.e., minimal recession of one material vs. another), (2) minimal smearing of one material into another, and (3) acceptable wear of machining tools. Examples of such material combinations are set forth in Table 1:

TABLE 1

| Structural Material | Sacrificial Material |
|---|---|
| Ni—P (P content preferably 11% or higher) | Cu |
| Au | Cu |
| Cu | Sn |
| Cu | Sn—Pb |
| Au | Sn |
| Au | Sn—Pb |

The Ni—P may be deposited via electroless deposition or electrolytically. If electroless Ni—P deposition is used, due to possible limitations on compatibility with some masking materials (e.g. photoresist), it may be desirable to blanket plate the Ni—P after pattern plating of Cu. Alternatively blanket deposition of Ni—P may be followed by selective etching of voids and then locating of sacrificial material therein. To reduce material cost, in some embodiments it may be desirable to pattern plate Au and then blanket deposit Cu. In other embodiments, it may be possible to reduce material costs by first selectively plating Cu then treating the Cu with one of the over-plating reduction techniques disclosed in U.S. patent application Ser. No. 10/841,100, filed May 7, 2004 by Cohen, et al., and entitled “Electrochemical Fabrication Methods Including Use of Surface Treatments to Reduce Overplating and/or Planarization During Formation of Multi-layer Three-Dimensional Structures”, which is hereby incorporated herein by reference as if set forth in full.

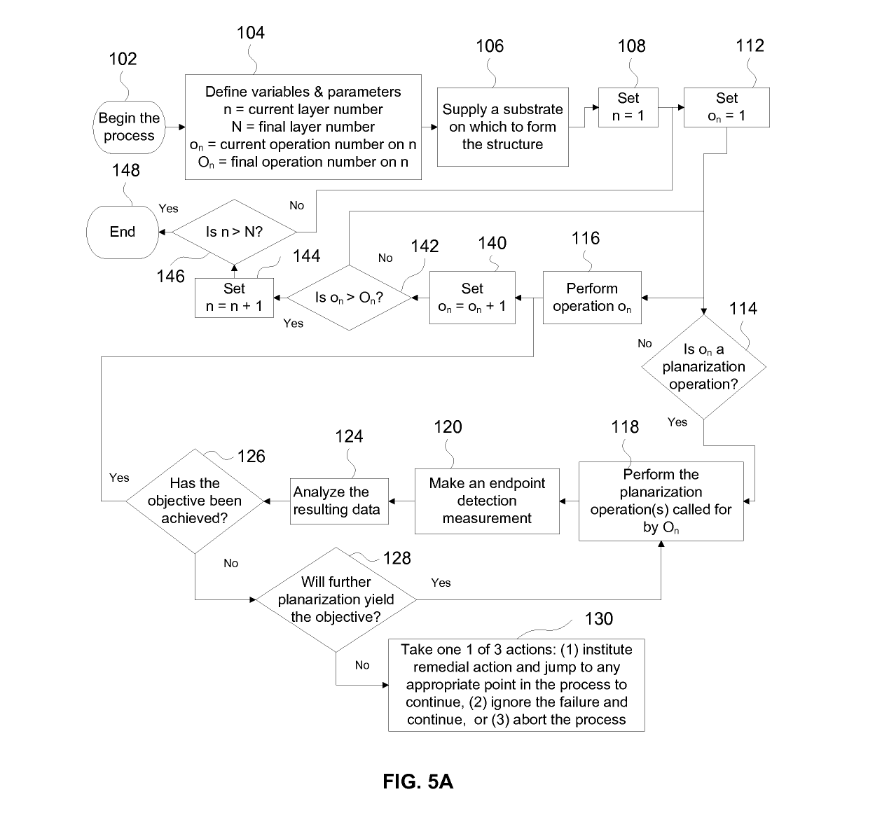

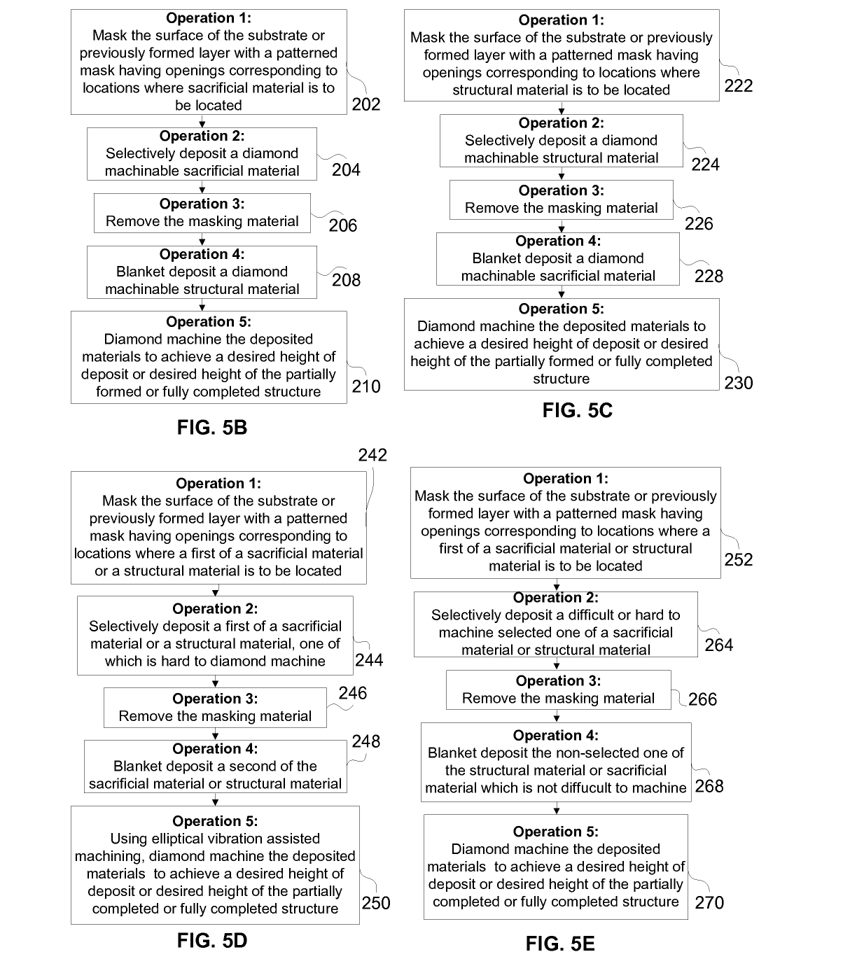

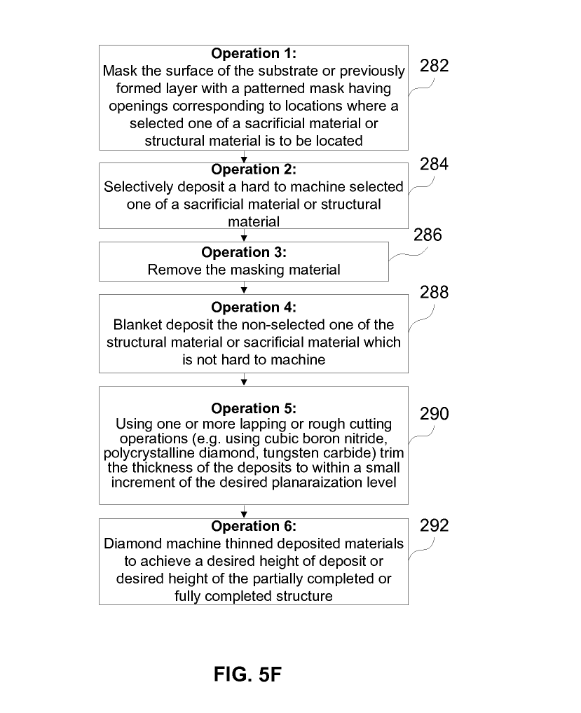

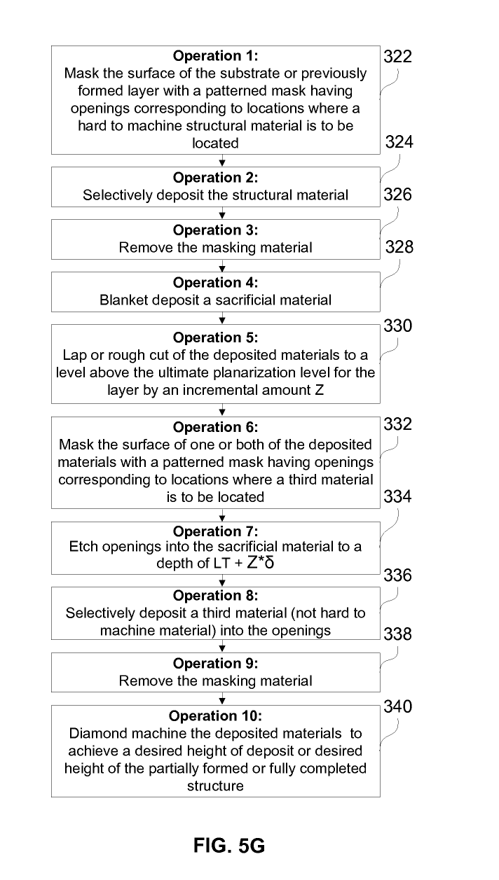

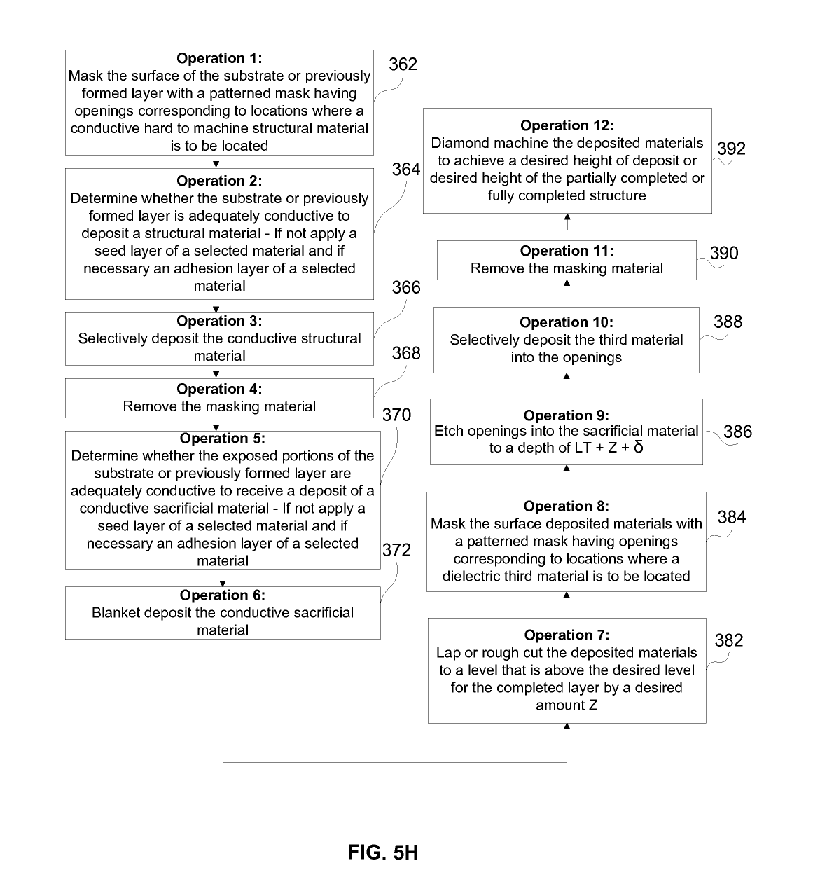

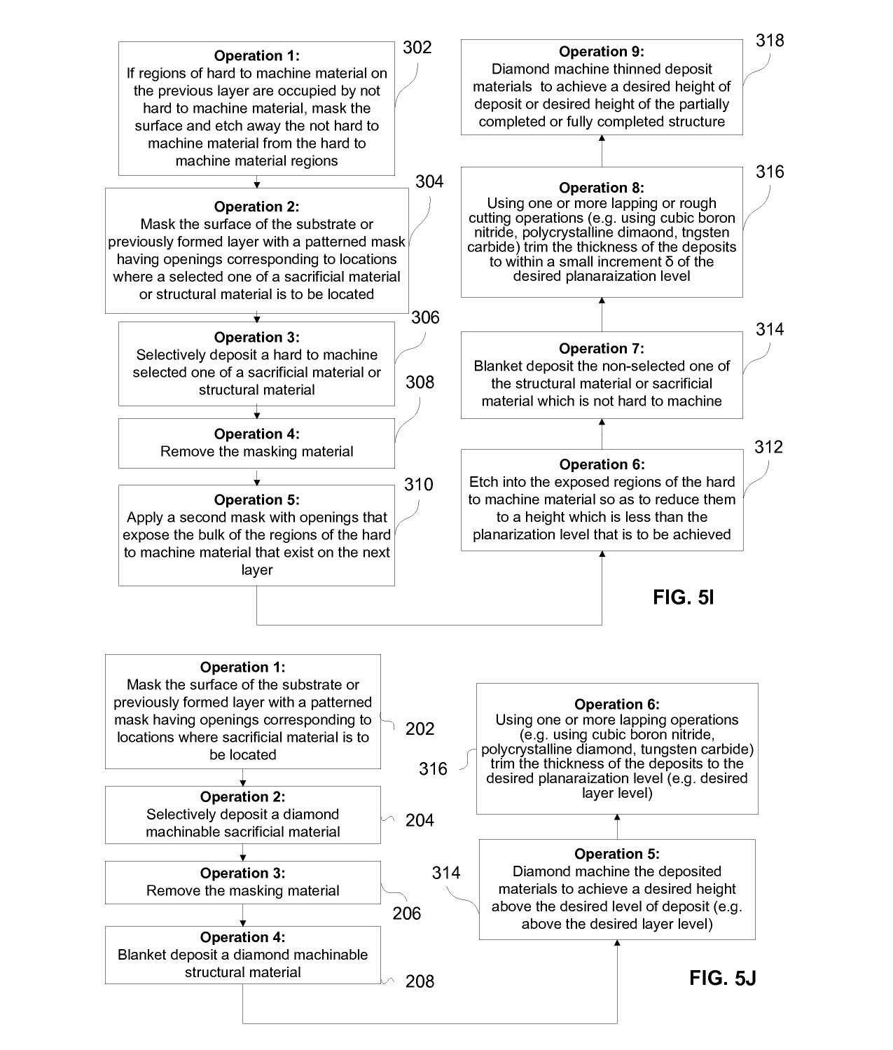

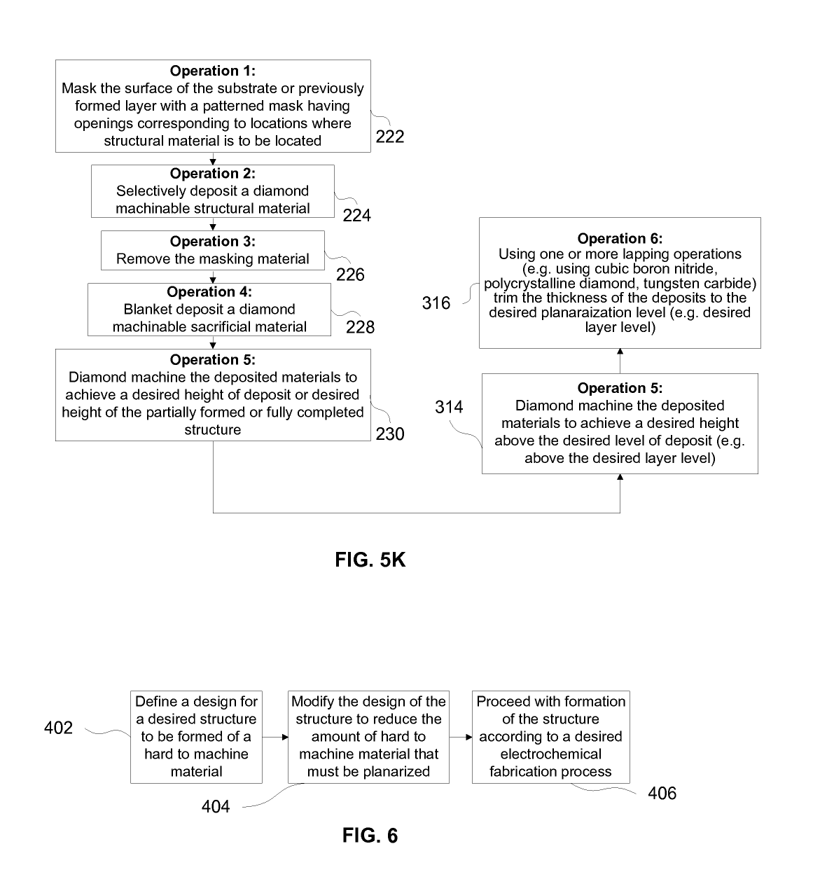

FIG. 5A provides a flow chart of an electrochemical fabrication process that may be followed in practicing some embodiments of the invention. The process of FIG. 5A begins with block 102 and then moves forward to block 104 which calls for the defining of variables and parameters. A current layer number variable “n” is defined, a final layer number parameter “N” is specified, a current operation number on layer n, oₙ, is defined and for each layer n a final operation number Oₙ is defined.

Next the process moves forward to block 106 which calls for the supplying of a substrate on which the structure will be formed. After which the process moves forward to block 108 which calls for the setting of the current layer number variable n to 1 (n=1) one and then onto block 112 which calls for the setting of the current operation number variable oₙ to 1 (oₙ=1).

Next the process moves forward to decision block 114 which makes an inquiry as to whether operation oₙ is a planarization operation. If a negative response is obtained, the process moves forward to block 116 which calls for the performance of operation oₙ and thereafter the process moves forward to block 140 which will be described herein later. If a positive response to the inquiry of block 114 is received, the process moves forward to block 118 which calls for the performance of the planarization operation or operations associated with the current value of oₙ and thereafter the process moves forward to block 120 which calls for the making of an endpoint detection measurement after which the process moves forward to block 124 which calls for an analysis of the endpoint detection data.

Next, the process moves forward to block 126 which inquires as to whether or not the planarization objective has been achieved. If the answer to this inquiry is “no” the process moves forward to block 128 which inquires as to whether additional planarization will yield the desired objective. If the answer is “yes”, the process loops back to block 118 where additional planarization operations will be performed, potentially using new parameters based on the fact that some amount of planarization has already occurred.

If block 128 produces a negative response, the process moves forward to block 130 which calls for the taking of one of three actions. The first of which is to institute some form of remedial action and then to jump to any appropriate point in the process to continue structure formation. Such remedial action may include the complete removal of the current layer, resetting of the operation number variable and moving back to block 114 to continue the process. Other remedial actions may involve re-depositing one or more materials and then continuing the process while other remedial actions may involve the recalibration or reworking of planarization fixtures, endpoint detection fixtures, or the like. Still other remedial actions may involve redeposition of some material and then use of a different planarization technique, such as multi-stage lapping, to replace the failed planarization technique.

A second action that may be taken may simply be to ignore the failure and continue the process as it may be determined that the failure on the given layer is not critical to the overall performance of the structure that is being formed.

A third action that may be taken may involve the aborting of the process and restarting it form the beginning or redesigning the structure and then starting the process over.

If block 126 produces a positive response, the process moves forward to block 140 which calls for incrementing the current operation number variable by one and then the process moves forward to block 142 which inquires as to whether the current operation number variable has exceeded the final operation variable number, Oₙ, for layer n. If the answer to this inquiry is “no”, the process loops back to block 114 for the performance of further operations on the present layer. If on the other hand this block produces a positive response, the process moves forward to block 144 which calls for the incrementing of the layer number variable, n, by one (n=n+1) after which the process moves forward to block 146 which inquires as to whether the current layer number variable, n, has exceeded the final layer number, N (n>N?). If this inquiry produces a positive response, the process moves forward to block 148 and ends. If on the other hand this inquiry produces a negative response, the process loops back to block 112 where the current operation number is reset to one so that operations may begin for creation of a next layer of the structure.

When block 148 is reached and the layer formation process ends, the formation of the structure may not yet be complete as various post processing operations may still need to occur. Such post processing operations may include, for example: (1) heat treating of the structures to improve interlayer adhesion, (2) release of the structure from any sacrificial material used during the layer formation process, (3) dicing of individual die regions on the substrate, (4) separation of the multiple simultaneously formed structures from the substrate on which they were formed, and/or (5) combining structures with other structures functionally or physically to build up desired systems or devices.

FIGS. 5B and 5C provide examples of process operations that may be performed in association with layers formed from the above noted combinations of structural and sacrificial materials. It should be understood that various other process operations are possible and that those set forth in FIGS. 5B and 5C are just examples of two simple versions of such processes.

The embodiment of FIG. 5B uses five operations to form a layer and in some embodiments the operations may be repeated to form additional layers. These operations may be used in producing a desired structure where these operations may be plugged into the process of FIG. 5A or be used in conjunction with a different processing scheme. Block 202 sets forth the first operation which calls for the locating of a mask on a surface of the substrate or previously formed layer where the mask is patterned so as to have openings which correspond to locations where a sacrificial material is to be located. Block 204 sets forth the second operation which calls for the selective depositing of a diamond machinable sacrificial material. Block 206 sets forth the third operation which calls for the removal of the masking material. Block 208 sets forth the fourth operation which calls for the blanket deposition of a diamond machinable structural material. Block 210 sets forth a fifth operation which calls for the diamond machining of the deposited materials to achieve a desired planarization level (i.e. a desired net height).

FIG. 5C sets forth operations similar to those of FIG. 5B with the exception that the structural material will be deposited first and the sacrificial material second. As a result of this change, block 222 sets forth the first operation which calls for a masking material to be located on the surface of the substrate or previously formed layer where openings in the masking material correspond to locations where structural material is to be located. Block 224 calls for the selective deposition of a diamond machinable structural material. Block 226 sets forth the third operation which calls for the removal of the masking material while block 228 sets forth the fourth operation which calls for the blanket deposition of a diamond machinable sacrificial material. Block 230, as did block 210 of FIG. 5B, calls for the diamond machining of the deposited materials.

Some materials and material combinations are inherently unsuited for general use with diamond machining but some embodiments of the invention incorporate operations and or restrictions that minimize the incompatibilities and thus allow diamond machining to be effectively used in conjunction with otherwise unusable materials and material combinations. Materials that are typically considered incompatible with diamond machining are Ni and Ni alloys (with the exception of Ni—P with a high percentage of P, e.g. greater than 11%). For example, Ni and Ni—Co are difficult to diamond machine due to chemical wear of the single-point diamond tool. In the context of EFAB, several methods can be used to minimize tool wear when using difficult to machine materials, and particular when using them as the structural material. Operations associated with some examples of such processes are set forth in the block diagrams of FIGS. 5D-5I. Operations such as those set forth in the examples of FIGS. 5D-5I may be implemented via a process such as that depicted in FIG. 5A or they may be implemented using different processes. It should also be understood that features of the various example processes may be combined with one another and/or with other processes to derive further embodiments. It should also be understood that the process set forth herein to deal with difficult to machine materials may also be used in conjunction with easier to machine materials without negative effect.

Operations for a first example process where planarization of a difficult to machine material is to occur are set forth in FIG. 5D. The first operation of FIG. 5D is set forth in block 242 which calls for the masking of the substrate or previously formed layer with a patterned mask having openings that correspond to locations where a first of a sacrificial material or a structural material is to be located. The second operation of the process is set forth in block 244 and involves the selective deposition of a first of the sacrificial material or the structural material wherein at least one of the materials is hard to diamond machine. The third operation of the process is set forth in block 246 which calls for the removal of the masking material. The fourth operation of the process is set forth in block 248 which calls for the blanket deposition of a second of the sacrificial material or structural material. The fifth, and final, operation of the process is set forth in block 250 which calls for the vibration assisted diamond machining of the deposited materials to achieve a desired planarization level (i.e. net deposition height).

Use of tool vibration has been described in the literature as a means of reducing tool wear and as a means for extending diamond machining to materials normally considered incapable of being diamond machined. An example of such a publication is “Vibration Assisted Diamond Turning using Elliptical Tool Motion,” by Dow, TA; Cerniway, M; Sohn, A; and Negishi, N, Proceedings of the ASPE, Vol 25, November 2001, pg 92-97. A copy of this article is set forth as Appendix A in U.S. Patent Application No. 60/534,159 which has been previously incorporated herein by reference. In alternative embodiments, as opposed to or in addition to using tool vibration to extend tool life, tool life may be extended by machining in an inert gas, machining in an atmosphere containing carbon, and/or machining at cryogenic temperatures. These methods may be applied to planarization operations during electrochemical fabrication.

Instead of trying to machine large, continuous expanses of difficult-to-machine (DM) material, tool wear may be decreased by machining only small amounts of DM material (e.g. structural material) which are embedded within an easily-machined material (e.g., a sacrificial material such as Cu or Sn). This result is partly due to simply having less DM material to machine, but may also be partly due to an effect similar to that produced using tool vibration: the tool no longer contacts DM material continuously but moves in and out of DM material. The amount of time spent machining embedded DM material is determined by the length of the DM feature along the tool path and the tangential speed of the tool relative to the workpiece surface. The time spent can be reduced by changing either of these factors; adjusting the length of the DM feature may impose a change on EFAB design rules. The ‘duty cycle’ (the % of time the tool spends in DM vs. easily-machined material) can also be adjusted by imposing design rules on the EFAB design and/or on the layout of die on a substrate or wafer. For example, the duty cycle may be limited to under 15%, more preferable under 10% and most preferably under 5%. Alternatively, the length of DM features may be limited such that no DM features are greater than 10 mm in length along the tool path, more preferably limited to less than 5 mm in length and more preferably less than 1 mm in length. More practically such limits on DM length may not be based on 100% of the encounters but some large percentage of encounters, e.g. 95%, 98% or even 99% so as to maximize tool life and reliability of planarization.

The amount of time that the tool spends machining the difficult-to-machine material may be reduced by: (1) pattern-plating the DM material and blanket plating the more easily-machined material; (2) pattern deposit both materials by either masking over the first deposited material or b inhibiting the deposition of the second material onto the surface of the first deposited material by treating the surface of the first deposited material; (3) plating the DM material with as uniform of a thickness as possible which is not significantly greater than the layer thickness; (4) lapping surface of the depositions down to a level which is slightly above final desired planed level (e.g. 0.5-2 microns above the target level) before diamond machining is used to cut the remaining material down to the final desired level; (5) rough cutting (e.g., using cubic boron nitride, polycrystalline diamond, tungsten carbide) the deposited materials down to a level which is slightly above the final desired planed level before diamond machining occurs; (6) avoiding the existence of as much of the DM material at and above the planarization level as possible during the time that planarization occurs, and/or (7) treat the surface of the hard to machine material to make it more readily machinable, e.g. treat or dope the surface of the hard to machine material with a second material (e.g. dope Ni with P) that changes the material properties of the first material to a depth sufficient to allow machining and, if necessary, remove any residual treatment or dopant after the machining is completed.

In either of techniques (4) or (5), enough material should be left above the final desired planarization level so that any subsurface damage caused by lapping or rough-cutting (it is believed that such surface/subsurface damage can contribute to curling of layers (i.e. distortion form flatness) once the structural material is released from the sacrificial material. The subsurface damage caused by the initial planarization operations may be removed by the diamond machining (which can produce less subsurface damage than some other methods).

An example of a process that implements the 1st technique (of reducing the amount of time that the tool spends cutting difficult to machine material) is set forth in the operations of FIG. 5E. Operation 1 of FIG. 5E is set forth in block 250 and calls for the masking of the surface of the substrate or previously formed layer with a patterned mask that has openings which correspond to locations where a first of a sacrificial material or a structural material is to be located. Operation 2 is set forth in block 264 and calls for the selective deposition of a hard to machine selected one of the sacrificial material or structural material. Operation 3 is set forth in block 266 and calls for the removal of the masking material. Operation 4 is set forth in block 268 and calls for the blanket deposition of the non-selected one of the structural material or sacrificial material which is not hard or difficult to machine. The 5th, and final, operation of the example process is set forth in block 270 and calls for the diamond machining of the deposited materials to achieve a desired level of planarized material.

Numerous variations of these operations are possible and will be apparent to those of skill in the art upon reviewing the teachings set forth herein. For example, the blanket deposition of Operation 4 may be replaced by a selective deposition operation. As another example, in some implementations the selected deposition of Operation 2 may be replaced by a blanket deposition and a subsequent selective etching operation. As a third example the two depositions of Operations 2 and 4 may be implemented, for example, via electroplating operations, electroless plating operations, or a combination thereof. As a fourth example, if one of the materials is a dielectric material, appropriate application of one or more seed layer materials may be utilized if necessary.

An example of a process that implements the 4th technique (for reducing the amount of time that the tool spends cutting difficult to machine material) is set forth in the operations of FIG. 5F. FIG. 5F sets forth six operations that may be used in forming one or more layers of a structure. The 1st operation is set forth in block 282 which calls for the masking of the surface of the substrate or previously formed layer with a patterned mask that has openings which correspond to locations where a selected one of a sacrificial material or structural material is to be located. Operation 2 is set forth in block 284 which calls for the selective deposition of a hard to machine selected one of the sacrificial or structural materials. The 3rd operation is set forth in block 286 which calls for the removal of the masking material. The 4th operation is set forth in block 282 and calls for the blanket deposition of the non-selected one of the structural and sacrificial materials. In this embodiment, it is assumed that the non-selected one of the materials is not hard or difficult to machine.

The 5th operation is set forth in block 290 which calls for using one or more lapping or rough cutting operations to trim the thickness of the deposits to within a small increment of a desired planarization level. The rough cutting operations, if used, may be based on using machine tool tips of cubic boron nitride, polysilicon diamond, or tungsten carbide, for example. The 6th operation is set forth in block 292 which calls for the diamond machining of the thinned down deposited materials such that a desired height of deposition (i.e. surface level) is achieved. As with the other sets of operations set forth herein, numerous variations of the operations described in this example are possible.

An example of a process that implements a variation of the 4th technique (of reducing the amount of time that the tool spends cutting difficult to machine material) is an embodiment that includes the formation of a structure from three-materials as set forth in the operations of FIG. 5G. The layer formation operations of FIG. 5G include ten separate operations. The 1st of which is set forth in block 322 which calls for the masking of the surface of the substrate or previously formed layer with a patterned mask having openings which correspond to locations where a hard to machine structural material is to be located. The 2nd operation of the process is set forth in block 324 which calls for the selective deposition of the structural material onto the substrate or previously formed layer via the openings in the mask. The 3rd operation of the process is set forth in block 326 which calls for the removal of the masking material. The fourth operation of the process is set forth in block 328 which calls for the blanket deposition of a sacrificial material. The 5th operation of the process is set forth in block 330 which calls for the lapping or rough cutting of the deposited materials to a level which is above, or short of, the ultimate planarization level for the layer. The planarization done in Operation 5 serves two purposes, one of which is the minimization of the thickness of the hard to machine material that will eventually be planarized using diamond machining and the other of which is the obtainment of a uniform working surface on which subsequent operations may be performed.

The 6th operation is set forth in block 332 which calls for the masking of the surface of one or both of the deposited materials with a patterned mask that has openings which correspond to locations where a 3rd material is to be located. In some variations of this process the openings may be made to occur over regions which previously received structural material only while in other variations the openings may be located over some regions that received structural material and other regions that received sacrificial material, while in still further variations the openings may be located over regions occupied by previously deposited sacrificial material only. In the present example it is assumed that the openings in the mask are located only above regions where sacrificial material was deposited.

The 7th operation of the process is set forth in block 334 which calls for the etching of openings into the sacrificial material to a depth which is the sum of the layer thickness plus an incremental tolerance based amount, δ, and an amount which is based on the difference between the rough cut planarization level and the final desired planarization level. The amount δ is set large enough to ensure that the bottom of the layer is reached but not so large that a void is inadvertently formed that extends an undesirable amount into a previous layer.

The 8th operation of this example is set forth in block 336 which calls for the selective deposition of a third material into the openings that have been etched into the sacrificial material. In the present example, it is assumed that the 3rd material is a material that is not difficult to machine. The 9th operation of the process is set forth in block 338 which calls for the removal of the masking material. The 10th operation of this example is set forth in block 340 which calls for the diamond machining of the deposited materials to achieve a desired net height of deposition (i.e. a desired planarization level).

An example of a process that implements a variation of the 4th technique (of reducing the amount of time that the tool spends cutting difficult to machine material) is an embodiment that includes the formation of a structure from three-materials (one of which is a dielectric material) as set forth in the operations of FIG. 5H. The example of FIG. 5H sets forth a twelve operation layer formation process which includes a rough cutting planarization operation and a diamond machining operation and which also includes the deposition of three materials, one of which is a sacrificial material.

The 1st operation of this example is depicted in block 362 which calls for the masking of the substrate or previously formed layer with a patterned mask having openings which correspond to locations where a conductive, hard to machine structural material is to be located.

The 2nd operation of this example is set forth in block 364 which calls for making a determination as to whether the substrate or previously formed layer is adequately conductive to allow deposition of the structural material. If it is determined that the substrate or previously formed layer is not adequately conductive a seed layer of a selected material and if necessary an adhesion layer of a selected material may be applied. If it is determined that the structural layer is adequately conductive the process proceeds to the 3rd operation.

The 3rd operation of the process is set forth in block 366 which calls for the selective deposition of a conductive structural material. The 4th operation of the process is set forth in block 368 which calls for the removal of the masking material.

The 5th operation of the process is set forth in block 370 which is similar to the second operation of the process as it calls for a determination of whether the exposed portions of the substrate or previously formed layer are adequately conductive to receive a deposit of a conductive sacrificial material. If it is determined that the substrate or previously formed layer is not adequately conductive then a seed layer of a selected material and if necessary an adhesion layer of a selected material may be applied. If it is determined that the structural layer is adequately conductive the process proceed to the 6th operation.

The 6th operation of the process is set forth in block 372 which calls for the blanket deposition of the conductive sacrificial material. The 7th operation of the process calls for the lapping or rough cutting of the deposited materials to a level that is above the desired level for the completed layer by a desired amount z.

The 8th operation of this example is set forth in block 384 which calls for the masking of the surface of the deposited materials with a patterned mask having openings that correspond to locations where a dielectric 3rd material is to be located. As with Operation 6 of FIG. 5G as set forth in block 332 the masking of this operation (Operation 8) and variations of this example may locate openings above the sacrificial material, the structural material, or a combination of both. In the present example it is assumed that the openings are located only over regions of sacrificial material. It is worth noting that in the present example, as well as in the example of FIG. 5F, as a selective etching operation is to be performed in the operation which is subsequent to the masking operation it may not be necessary that the openings in the masking material identically correspond to regions to be etched if such regions are in whole or in part bounded by material that will not be attacked by the particular etchant utilized. As such, in some variations of these examples it may be possible to use masks that deviate from exact etching patterns in certain ways.

Operation 9 of the present example is set forth in block 386 which calls for the etching of openings into the sacrificial material where the openings are etched to a depth equal to the layer thickness plus the amount z plus an incremental amount δ (LT+z+δ). The incremental amount may be associated with a tolerance, or uncertainty, in the exact separation between the upper surface being etched and the location of the bottom of the layer.

Operation 10 is set forth in block 388 which calls for the selective deposition of a 3rd material into the openings that were etched into the sacrificial material.

The 11th operation of this example is set forth in block 390 which calls for the removal of the masking material which was applied in Operation 8.

The 12^{th}, and final, operation of this example calls for diamond machining of the deposited materials to achieve a desired planarization level (i.e. a bounding level for the present layer).

As with the other examples set forth herein numerous variations are possible and will be understood by those of skill in the art after studying the teachings set forth herein. Two such variations may be based on the use of either the 1st masking material applied in Operation 1 or the 2nd masking material applied in Operation 8 as one of the building materials from which layers are to be built up.

The avoidance approach of the 6^{th} technique may be implemented in a variety of different ways, for example, a first implementation might involve depositing the DM material (i.e. difficult to machine material) in all desired locations to an approximately uniform depth and then selectively etching into selected regions (e.g. regions which will be overlaid by the DM material deposited in association with the formation of the next layer). The depth of etching preferably extends at least an incremental amount below the final desired planarization level such that DM material in that portion of the cross-section never undergoes planarization. During continued formation of the layer, if desired, the etched openings may be filled in with an easy to planarize material. Then during formation of a next layer the opening may be etched free of the easy to planarize material and the difficult-to-planarize material may be deposited to fill the voids while it is being deposited to desired locations associated with the next layer. In another alternative, it may not be necessary to back fill the voids prior to planarization as any surface oddities that result near the edge of an unfilled void may simply be hidden by the deposition associated with formation of the next layer. Alternatively to avoid undesired over filling of some areas, the filling of the opening and the depositing of the DM for the next layer may be performed in separate selective filling operations. In still other alternatives, the openings filled with the more easily machinable material may remain filled with the easily machinable material which may simply become trapped therein as a result of depositing the DM material in association with the next layer.

An example of a process that provides an implementation of the 6^{th} technique is set forth in the operations of FIG. 5I. This example also implements a two step planarization process of the 4^{th} technique. The example of FIG. 5I reduces tool wear by (1) using a lapping operation or initial rough cutting operation to trim a thickness of deposited material to a level which is closer to a final desired planarization level and (2) using an etching operation to remove portions of the difficult to machine material from regions where planarization will occur. The layer formation process of FIG. 5I includes nine operations.

The first operation is set forth in block 302. This first operation is a conditional operation which indicates that if regions of hard to machine material on the previous layer are temporarily occupied by a not hard to machine material then the surface of the previous layer should be masked such that some regions of the layer are shielded and such that openings exist in the masking material which leave those regions exposed where the temporarily located, not hard to machine material is to be removed. The operation also calls for the etching away of the not hard to machine material from those temporary locations.

The second operation of the process is set forth in block 304 and calls for the masking of the substrate or previously formed layer with a patterned mask that has openings which correspond to locations where a selected one of a sacrificial material or structural material is to be located.

The third operation is set forth in block 306 which calls for the selective deposition of a hard to machine selected one of the sacrificial material or structural material (i.e. the material for which openings were made in the mask of Operation 2).

The fourth operation is set forth in block 308 which calls for the removal of the masking material.

The fifth operation of the process is set forth in block 310 which calls for the application of a second mask which includes openings that expose selected regions of the hard to machine material that will exist on the next layer. The regions that are to be etched are those which represent the bulk of the intersection regions between locations of hard to machine material on the present layer and hard to machine material on the next layer. Though in some implementations it may be acceptable to etch boundary portions of the intersecting regions, in other implementations it is preferred that boundary portions of the intersecting regions not be subjected to etching.

The sixth operation of the process is set forth in block 312 which calls for the etching of the exposed regions of the hard to machine material so as to reduce them to a height which locates their upper surfaces below the planarization level that is to be achieved.

The seventh operation is set forth in block 314 which calls for the blanket deposition of the non-selected one of the structural material and sacrificial material. In this process it is assumed that this non-selected material is not hard or difficult to machine.

The eighth operation of the process is set forth in block 316 while the ninth operation is set forth in block 318. Blocks 316 and 318, respectively, call for the lapping or rough cutting of the deposited materials and then the diamond machining of the remaining material to trim the deposit height to the desired planarization level. The operations of blocks 316 and 318 are analogous to those set forth in block 290 and 292 respectively of FIG. 5F. As a result of the etching operations of this embodiment there was less of the difficult to machine material present during diamond machining operations and thus less tool wear. Furthermore, due to the fact the etched regions represented intersections between regions on the present layer with those on the next layer, the etched regions will be filled in with the common material during formation of the next layer without any loss of structural accuracy but possibly with an enhancement in structural integrity.

A second implementation may involve the dispensing of the hard to machine material in a two step process, e.g. deposit all desired locations to a first height (which extends to a level below that of the final desired planarization level), and then in a second deposit build up the height of deposition in selected locations. Alternatively, deposit selected locations to a final desired height and then deposit other selected locations to a different final desired height, where one of the heights locates material at or above the desired layer level and the other locates material below the height of the layer level.

A third implementation may involve modifying the data representing the three-dimensional structure so as to define it as a shell or envelop of difficult-to-machine structural material that encapsulates an easy-to-machine material. Alternatively, the structure may be defined as an envelope of structural material that surrounds an internal grid of structural material with intermediate regions of sacrificial material. FIG. 6 sets forth a block diagram of this third implementation of the 6^{th} approach. In such approaches, hatch width may be set to a desired amount. For example, hatching width may be set 200 microns, 100 microns, or even 5-30 microns and spacing between parallel hatch elements set to, e.g. more than 1 mm, less than one millimeter or even equivalent to the hatch width itself. Hatch elements may be lines, points, polygons circular, or other smoothly curved patterns, they may criss-cross one another or stop short of contacting each other and/or contact wall elements. Wall elements may have narrower, wider, or similar widths to hatch elements when not up-facing or down facing. In up-facing or down facing regions the wall elements may have minimum widths necessary to bridge the up-facing or down-facing regions between successive layers and/or be formed in combination with one or more of the other techniques set forth herein.

FIGS. 5J and 5K provide examples of process operations that are similar to those of FIGS. 5B and 5C with the exception that the planarization by diamond machining (i.e. single point diamond fly cutting or turning) doesn't bring the level of planarization to a desired final level (e.g. a level corresponding to a boundary of a layer being formed) but instead stops short of that level and thereafter one or more lapping operations are used to complete the planarization process (i.e. to bring the planarized surface to a desired level). The end level for diamond machining may be set in a variety of ways: (1) above the estimated or known maximum deposition height of the first deposited material, (2) above the estimated or known nominal height (e.g. average height) of the first deposition material, (3) above a maximum or nominal height of a hard to fly cut or turn material whether it be a first deposited material or a subsequently deposited material. This approach may provide one or more advantages. For example, if one of the material being used is hard to fly cut or turn, it may be deposited first such that the fly cutting or turning can be used to remove a large portion of the second material and maybe a small amount of the first material, in a rapid manner while leaving the slower work of removing the bulk of the additional first material (i.e. the material that is above the desired planarization level) with a slower but more compatible lapping operation or series of operations). Various other process operations are possible and those set forth in FIGS. 5B and 5C are just examples of two simple versions of such processes.

With the exception of Blocks 314 and 316 in both FIGS. 5J and 5K the other steps of the processes are similar to those discussed above in association with FIGS. 5B and 5C. Block 314 sets forth a fifth operation which calls for the diamond machining of the deposited materials to achieve a planarization level that is above a desired final planarization level while Block 316 sets forth a sixth operation which calls for the completion of the planarization via one or more lapping operations.

Various alternatives exist to the ninth and tenth embodiments of FIGS. 5J and 5K. Some of these embodiments will take the earlier diamond machining operation(s) and later lapping operations and apply them to some of the other embodiments discussed above (e.g. the embodiments of FIGS. 5D and 5E) and the alternative discussed below (e.g. diamond machining may be replaced by single point fly cutting or turning using other cutting materials).

Various other embodiments of the present invention exist. Some of these embodiments may be based on a combination of the teachings herein with various teachings incorporated herein by reference. Some embodiments may not use any blanket deposition processes. Some embodiments may involve the selective deposition of a plurality of different materials on a single layer or on different layers. Some embodiments may use selective deposition processes or blanket deposition processes on some layers, or on all layers, that are not electrodeposition processes. Some embodiments may use nickel as a structural material while other embodiments may use different materials. Some embodiments may use copper as the structural material with or without a sacrificial material. Some embodiments may remove a sacrificial material while other embodiments may not include use of a sacrificial material but instead use two, three, or more structural materials in forming each layer. For example, in some embodiments, two materials may be deposited per layer and both may be structural materials (e.g. one may be a dielectric of the polymeric, oxide, or ceramic type while the other is a conductive material). In some alternative embodiments, diamond fly cutting planarization operations may be replaced with fly cutting operations based on other tool materials. In some embodiments, selective depositions of conductive and or dielectric materials may occur without using masks but instead using direct writing techniques.

As noted previously, in some of the implementations set forth above, the electrochemical fabrication methods set forth herein may involve the use of selective etching operations to minimize the amount of difficult-to-machine material that is encountered by diamond machining operations. As noted above some embodiments may form structures on a layer-by-layer basis but deviate from a strict planar layer on planar layer build up process in favor of a process that interlacing material between the layers. Such alternating build processes are more fully disclosed in U.S. application Ser. No. 10/434,519, filed on May 7, 2003, entitled “Methods of and Apparatus for Electrochemically Fabricating Structures Via Interlaced Layers or Via Selective Etching and Filling of Voids” which is herein incorporated by reference as if set forth in full.

The techniques disclosed herein may be combined with the techniques disclosed in the following patent applications which are focused on the formation of structures on dielectric substrates and/or the formation of structures that incorporate dielectric materials during the formation process and possibility into the final structures as formed. The first of these applications is U.S. Patent Application No. 60/534,184, which is entitled “Electrochemical Fabrication Methods Incorporating Dielectric Materials and/or Using Dielectric Substrates”. The second of these applications is U.S. Patent Application No. 60/533,932, which is entitled “Electrochemical Fabrication Methods Using Dielectric Substrates”. The third of these applications is U.S. Patent Application No. 60/534,157 which is entitled “Electrochemical Fabrication Methods Incorporating Dielectric Materials”. The fourth of these applications is U.S. patent application Ser. No. 10/841,300, which is entitled “Methods for Electrochemically Fabricating Structures Using Adhered Masks, Incorporating Dielectric Sheets, and/or Seed layers That Are Partially Removed Via Planarization”. The fifth of these applications is U.S. patent application Ser. No. 10/841,378, which is entitled “Electrochemical Fabrication Method for Producing Multi-layer Three-Dimensional Structures on a Porous Dielectric”. These patent applications are each hereby incorporated herein by reference as if set forth in full herein.

The planarization techniques disclosed herein may be combined with planarization end point detection and parallelism maintenance techniques disclosed in U.S. patent application Ser. No. 11/028,943 which was filed on Jan. 3, 2005 by Cohen et al. and which is entitled “Method and Apparatus for Maintaining Parallelism of Layers and/or Achieving Desired Thicknesses of Layers During the Electrochemical Fabrication of Structures”. This referenced application is incorporated herein as if set forth in full herein.

Due to the reduction in smearing that may result from use of diamond machining as opposed to lapping, electrochemical fabrication processes that form structures from materials with greatly differing hardness may benefit from the use of diamond lapping in the performance of at least some planarization operations. Some such variations in hardness may exist in embodiments where dielectric materials will be used along with metals.

Microprobe arrays (i.e. arrays of compliant electronic contact elements) may represent a viable application for the use of diamond machining. HM materials may be incorporated into the probe arrays as individual probe elements that, in many cases, have relatively small regions of HM structural material surrounded by relatively large regions of sacrificial materials. Further teaching about microprobes and electrochemical fabrication techniques are set forth in a number of US patent applications. These applications include: (1) U.S. Patent Application No. 60/641,341 by Chen, et al., filed Jan. 3, 2005, and entitled “Vertical Microprobes for Contacting Electronic Components and Method for Making Such Probes”; (2) U.S. Patent Application No. 60/533,975, filed Dec. 31, 2003, by Kim et al. and which is entitled “Microprobe Tips and Methods for Making”; (3) U.S. Patent Application No. 60/533,947, by Kumar et al., filed Dec. 31, 2003, and which is entitled “Probe Arrays and Method for Making”; (4) U.S. Patent Application No. 60/533,948 by Cohen et al., filed Dec. 31, 2003 and which is entitled “Electrochemical Fabrication Method for Co-Fabricating Probes and Space Transformers”; and (5) U.S. Patent Application No. 60/533,897, filed Dec. 31, 2004, by Cohen et al. and which is entitled “Electrochemical Fabrication Process for Forming Multilayer Multimaterial Microprobe structures”. These patent filings are each hereby incorporated herein by reference as if set forth in full herein.

In view of the teachings herein, many further embodiments, alternatives in design and uses of the instant invention will be apparent to those of skill in the art. As such, it is not intended that the invention be limited to the particular illustrative embodiments, alternatives, and uses described above but instead that it be solely limited by the claims presented hereafter.

We claim:

1. A fabrication process for forming a multi-layer three-dimensional structure, comprising:
(a) forming and adhering a layer of material to a previously formed layer and/or to a substrate, wherein the layer comprises a desired pattern of at least one material, wherein one or more contact pads exist on the substrate or on a previously formed layer;
(b) subjecting the at least one material to a planarization operation which comprises diamond machining; and
(c) repeating the forming and adhering of operation (a) one or more time to form the three-dimensional structure from a plurality of adhered layers.

2. The process of claim 1 wherein forming and adhering of the layer of material involves the deposition of a first material and followed by deposition of a second material wherein at least one of the first or second materials is deposited via an electroplating operation.

3. The process of claim 2 wherein the first and second materials comprise Ni—P and Cu.

4. The process of claim 2 wherein the first and second materials comprise Au and Cu.

5. The process of claim 2 wherein the first and second materials comprise Cu and Sn.

6. The process of claim 2 wherein the first material is more difficult to machine than the second material.

7. The process of claim 2 wherein the first material is a structural material and wherein the second material is a sacrificial material.

8. The process of claim 2 wherein the structure comprises an envelope of structural material surrounding an entrapped quantity of sacrificial material, wherein the structural material is more difficult to machine using diamond machining than the sacrificial material.

9. The process of claim 2 wherein the structure comprises an envelope of structural material surrounding an entrapped quantity of sacrificial material, wherein the structural material is more difficult to machine using diamond machining than the sacrificial material.

10. The process of claim 9 wherein the envelope of structural material also surrounds a grid of structural material.

11. The process of claim 2 wherein the planarization operation additionally comprises vibration assisted machining.

12. The process of claim 2 wherein prior to subjecting the deposited material to the planarization operation, the first deposited material is subjected to a selective etching operations that removes a portion of the first material to a level below a final desired planarization level in regions where the etched first material will be overlaid by first material deposited in association with the next layer.

13. The process of claim 1 wherein forming and adhering of the layer of material involves the deposition of a first material, followed by deposition of a second material, and followed by deposition of at least a third material wherein at least one of the first, second, or third materials is deposited via an electroplating operation.

14. The process of claim 1 wherein the diamond machining brings height of deposition to a level which is closer to that of the final desired level and after which one or more lapping operations are used to bring the level of the deposited materials to a level that is within a defined tolerance of a desired level.

15. The process of claim 1 wherein the planarization operation includes at least one lapping operation or rough cutting operation that brings height of deposition to a level which is closer to that of the final desired level and after which the diamond machining operation brings the level of the deposited materials to a level that is within a defined tolerance of a desired level.

16. The process of claim 16 wherein the lapping or rough cutting substantially planarizes the surfaces and where a difference between the material surface subjected to the lapping or rough cutting is spaced from the final desired planarization level by an amount which is equal to or greater than a depth to which the lapping or rough cutting causes subsurface damage.

17. The process of claim 1 wherein the diamond machining is single point diamond fly cutting.

18. The process of claim 1 wherein the diamond machining is single point diamond turning.
